(19) United States
(12) Patent Application Publication
(10) Pub. No.: US 2019/0050874 A1
(43) Pub. Date: Feb. 14, 2019

(54) ASSOCIATING IP ADDRESSES WITH LOCATIONS WHERE USERS ACCESS CONTENT

(71) Applicant: Bombora, Inc., New York, NY (US)

(72) Inventors: Erik Gregory MATLICK, Miami Beach, FL (US); Robert James ARMSTRONG, Reno, NV (US); Benny LIN, New York, NY (US); Nicholaus Eugene HALECKY, Reno, NV (US); Will KURT, Boston, MA (US)

(21) Appl. No.: 16/163,283

(22) Filed: Oct. 17, 2018

Related U.S. Application Data
(63) Continuation-in-part of application No. 14/981,529, filed on Dec. 28, 2015.
Application No. 14/981,529 is a continuation-in-part of application No. 14/498,056, filed on Sep. 26, 2014, now Pat. No. 9,940,634.

(51) Int. Cl. G06Q 30/02; G06F 17/30; H04L 29/08

(52) U.S. Cl. CPC G06Q 30/0201; H04L 67/306; H04L 67/22; G06F 17/30112

(57) ABSTRACT

A content consumption monitor (CCM) receives events identifying how and when users access content. The CCM may identify internet protocol (IP) addresses associated with the events and determine types of establishments associated with the IP addresses based on how the users access the content at the IP addresses. The CCM may generate consumption scores for the IP addresses based on the identified types of establishments. For example, the CCM can generate consumption scores for IP addresses associated with private business locations. The CCM can generate more accurate intent and consumption data by filtering out events unrelated to company content consumption.

The present application is a continuation in part of U.S. patent application Ser. No. 14/981,529, entitled: SURGE DETECTOR FOR CONTENT CONSUMPTION, filed Dec. 28, 2015; which is a continuation in part of U.S. patent application Ser. No. 14/498,056, entitled: CONTENT CONSUMPTION MONITOR, filed Sep. 26, 2014, now issued as U.S. Pat. No. 9,940,634, which are each herein incorporated by reference in their entireties.

### BACKGROUND

Domain mapping services may map domain names to different internet protocol (IP) addresses. Analytic services link IP related analytic data with the associated domain names or business names. For example, a business intelligence company may use the IP data to target different types of advertising to different companies.

The same company may use multiple different IP addresses. Some of the IP addresses may be used at private business locations and other IP addresses may be used at public business locations. For example, a coffee company may use a first set of IP addresses for corporate office locations and use a second set of IP addresses for retail coffee shop locations. In a second example, an entertainment company may use a first set of IP addresses at their corporate offices and use a second set of IP addresses at their amusement parks or casinos.

Domain mapping services may only associate one domain name with all of the IP addresses associated with a company and not distinguish between the private and public business locations. Analytic data derived from the coffee shops and amusement parks may not accurately indicate the interests of employees who work for the company at corporate office locations. Thus, analytics generated from IP related data may not accurately identify topics of interest to companies.

### BRIEF DESCRIPTION OF THE DRAWINGS

FIG. 1 depicts an example content consumption monitor (CCM).

FIG. 2 depicts an example of the CCM in more detail.

FIG. 3 depicts an example operation of a CCM tag.

FIG. 4 depicts example events processed by the CCM.

FIG. 5 depicts an example user intent vector.

FIG. 6 depicts an example process for segmenting users.

FIG. 7 depicts an example process for generating company intent vectors.

FIG. 8 depicts an example consumption score generator.

FIG. 9 depicts the example consumption score generator in more detail.

FIG. 10 depicts an example process for identifying a surge in consumption scores.

FIG. 11 depicts an example process for calculating initial consumption scores.

FIG. 12 depicts an example process for adjusting the initial consumption scores based on historic baseline events.

FIG. 13 depicts an example process for mapping surge topics with contacts.

FIG. 14 depicts an example content consumption monitor calculating content intent.

FIG. 15 depicts an example process for adjusting a consumption score based on content intent.

FIG. 16 depicts an example IP classification system.

FIG. 17 depicts an example of the IP classification system of FIG. 16 in more detail.

FIG. 18 depicts an example of how the content consumption monitor uses an IP entity map to generate consumption data.

FIG. 19 depicts an example feature dataset generated by the IP classification system.

FIG. 20 depicts an example process for generating the feature dataset in FIG. 19.

FIG. 21 depicts an example computing device for the CCM.

### DETAILED DESCRIPTION

A content consumption monitor (CCM) receives events identifying how and when users access content. The CCM may identify internet protocol (IP) addresses associated with the events and associate the IP addresses with locations where the users access the content. The CCM may determine types of establishments associated with the IP addresses based on how and when the users access the content at the IP locations. The CCM then may generate consumption scores for the IP addresses more likely to be associated with private business locations.

For example, the CCM may identify the establishment as a private business location when a particular percentage of the events, or a particular number of the events from a particular user, occur during business hours. This may distinguish the IP address from public business locations, such as coffee shops or amusement parks, where users may view content at all hours of the day or view smaller amounts of content.

In another example, the CCM may identify the establishment as a private business location when a particular percentage of the users access content over a relative long period of time. This may indicate private business locations, such as corporate offices, where employees generally access content at the same IP location for longer periods of time during work hours.

In another example, the CCM may identify the types of computing devices used for accessing content at the different IP addresses. IP address locations where users mostly access content via smart phones may indicate public business locations, such as coffee shops and casinos.

The CCM can generate more accurate intent data by distinguishing company events from general public or customer events. The CCM uses processing resources more efficiently by generating certain consumption scores only for business related intent data. The CCM also may provide more secure IP analytics by generating consumption scores for IP addresses without using personally identifiable information (PII).

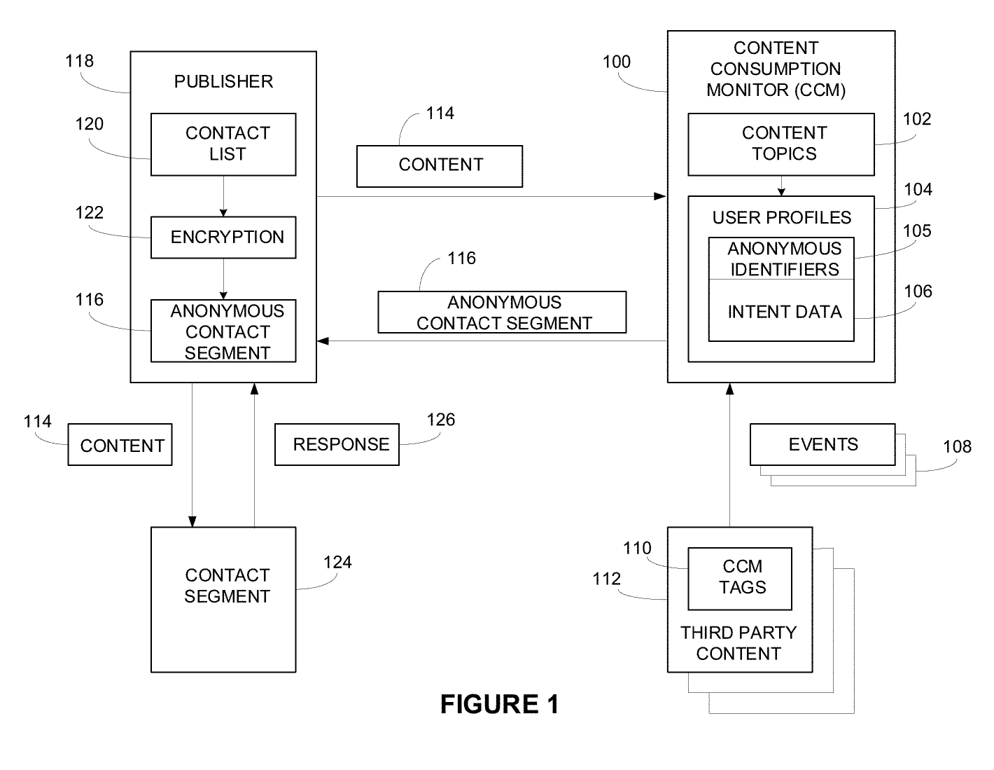

FIG. 1 depicts a content consumption monitor (CCM) 100. CCM 100 may be a server or any other computing system that communicates with a publisher 118 and monitors user accesses to third party content 112. Publisher 118 is any server or computer operated by a company or individual that wants to send content 114 to an interested group of users. This group of users is alternatively referred to as contact segment 124.

For example, publisher 118 may be a company that sells electric cars. Publisher 118 may have a contact list 120 of email addresses for customers that have attended prior seminars or have registered on the publisher website. Contact list 120 also may be generated by CCM tags 110 that are described in more detail below. Publisher 118 also may generate contact list 120 from lead lists provided by third parties lead services, retail outlets, and/or other promotions or points of sale, or the like or any combination thereof. Publisher 118 may want to send email announcements for an upcoming electric car seminar. Publisher 118 would like to increase the number of attendees at the seminar.

Third party content 112 comprises any information on any subject accessed by any user. Third party content 112 may include web pages provided on website servers operated by different businesses and/or individuals. For example, third party content 112 may come from different websites operated by on-line retailers and wholesalers, on-line newspapers, universities, blogs, municipalities, social media sites, or any other entity that supplies content.

Third party content 112 also may include information not accessed directly from websites. For example, users may access registration information at seminars, retail stores, and other events. Third party content 112 also may include content provided by publisher 118.

Computers and/or servers associated with publisher 118, content segment 124, CCM 100 and third party content 112 may communicate over the Internet or any other wired or wireless network including local area networks (LANs), wide area networks (WANs), wireless networks, cellular networks, Wi-Fi networks, Bluetooth® networks, cable networks, or the like, or any combination thereof.

Some of third party content 112 may contain CCM tags 110 that capture and send events 108 to CCM 100. For example, CCM tags 110 may comprise JavaScript added to website web pages. The website downloads the web pages, along with CCM tags 110, to user computers. User computers may include any communication and/or processing device including but not limited to laptop computers, personal computers, smart phones, terminals, tablet computers, or the like, or any combination thereof. CCM tags 110 monitor web sessions send some captured web session events 108 to CCM 100.

Events 108 may identify third party content 112 and identify the user accessing third party content 112. For example, event 108 may include a universal resource locator (URL) link to third party content 112 and may include a hashed user email address or cookie identifier associated with the user that accessed third party content 112. Events 108 also may identify an access activity associated with third party content 112. For example, event 108 may indicate the user viewed a web page, downloaded an electronic document, or registered for a seminar.

CCM 100 builds user profiles 104 from events 108. User profiles 104 may include anonymous identifiers 105 that associate third party content 112 with particular users. User profiles 104 also may include intent data 106 that identifies topics in third party content 112 accessed by the users. For example, intent data 106 may comprise a user intent vector that identifies the topics and identifies levels of user interest in the topics.

As mentioned above, publisher 118 may want to send an email announcing an electric car seminar to a particular contact segment 124 of users interested in electric cars. Publisher 118 may send the email as content 114 to CCM 100. CCM 100 identifies topics 102 in content 114.

CCM 100 compares content topics 102 with intent data 106. CCM 100 identifies the user profiles 104 that indicate an interest in content 114. CCM 100 sends anonymous identifiers 105 for the identified user profiles 104 to publisher 118 as anonymous contact segment 116.

Contact list 120 may include user identifiers, such as email addresses, names, phone numbers, or the like, or any combination thereof. The identifiers in contact list 120 are hashed or otherwise de-identified by an algorithm 122. Publisher 118 compares the hashed identifiers from contact list 120 with the anonymous identifiers 105 in anonymous contact segment 116.

Any matching identifiers are identified as contact segment 124. Publisher 118 identifies the unencrypted email addresses in contact list 120 associated with contact segment 124. Publisher 118 sends content 114 to the email addresses identified for contact segment 124. For example, publisher 118 sends email announcing the electric car seminar to contact segment 124.

Sending content 114 to contact segment 124 may generate a substantial lift in the number of positive responses 126. For example, assume publisher 118 wants to send emails announcing early bird specials for the upcoming seminar. The seminar may include ten different tracks, such as electric cars, environmental issues, renewable energy, etc. In the past, publisher 118 may have sent ten different emails for each separate track to everyone in contact list 120.

Publisher 118 may now only send the email regarding the electric car track to contacts identified in contact segment 124. The number of positive responses 126 registering for the electric car track of the seminar may substantially increase since content 114 is now directed to users interested in electric cars.

In another example, CCM 100 may provide local ad campaign or email segmentation. For example, CCM 100 may provide a “yes” or “no” as to whether a particular advertisement should be shown to a particular user. In this example, CCM 100 may use the hashed data without re-identification of users and the “yes/no” action recommendation may key off of a de-identified hash value.

CCM 100 may revitalize cold contacts in publisher contact list 120. CCM 100 can identify the users in contact list 120 that are currently accessing other third party content 112 and identify the topics associated with third party content 112. By monitoring accesses to third party content 112, CCM 100 may identify current user interests even though those interests may not align with the content currently provided by publisher 118. Publisher 118 might reengage the cold contacts by providing content 114 more aligned with the most relevant topics identified in third party content 112.

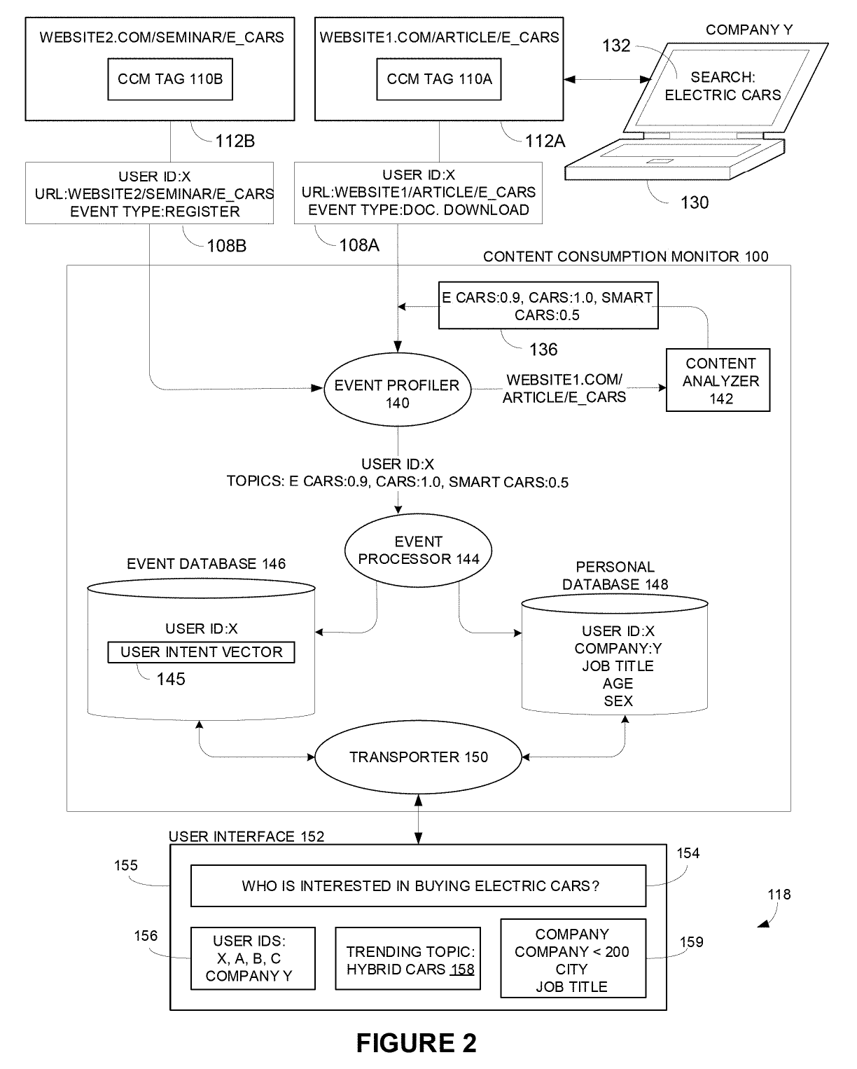

FIG. 2 is a diagram explaining the content consumption manager in more detail. A user may enter a search query 132 into a computer 130 via a search engine. The user may work for a company Y. For example, the user may have an associated email address USER@COMPANY_Y.com.

In response to search query 132, the search engine may display links to content 112A and 112B on website1 and website2, respectively. The user may click on the link to website1. Website1 may download a web page to computer 130 that includes a link to a white paper. Website1 may include one or more web pages with CCM tags 110A that capture different events during the web session between website1 and computer 130. Website1 or another website may have downloaded a cookie onto a web browser operating on computer 130. The cookie may comprise an identifier X, such as a unique alphanumeric set of characters associated with the web browser on computer 130.

During the web session with website1, the user of computer 130 may click on a link to white paper 112A. In response to the mouse click, CCM tag 110A may download an event 108A to CCM 100. Event 108A may identify the cookie identifier X loaded on the web browser of computer 130. In addition, or alternatively, CCM tag 110A may capture a user name and/or email address entered into one or more web page fields during the web session. CCM tag 110 hashes the email address and includes the hashed email address in event 108A. Any identifier associated with the user is referred to generally as user X or user ID.

CCM tag 110A also may include a link in event 108A to the white paper downloaded from website1 to computer 130. For example, CCM tag 110A may capture the universal resource locator (URL) for white paper 112A. CCM tag 110A also may include an event type identifier in event 108A that identifies an action or activity associated with content 112A. For example, CCM tag 110A may insert an event type identifier into event 108A that indicates the user downloaded an electric document.

CCM tag 110A also may identify the launching platform for accessing content 112B. For example, CCM tag 110B may identify a link www.searchengine.com to the search engine used for accessing website1.

An event profiler 140 in CCM 100 forwards the URL identified in event 108A to a content analyzer 142. Content analyzer 142 generates a set of topics 136 associated with or suggested by white paper 112A. For example, topics 136 may include electric cars, cars, smart cars, electric batteries, etc. Each topic 136 may have an associated relevancy score indicating the relevancy of the topic in white paper 112A. Content analyzers that identify topics in documents are known to those skilled in the art and are therefore not described in further detail.

Event profiler 140 forwards the user ID, topics 136, event type, and any other data from event 108A to event processor 144. Event processor 144 may store personal information captured in event 108A in a personal database 148. For example, during the web session with website1, the user may have entered an employer company name into a web page form field. CCM tag 110A may copy the employer company name into event 108A. Alternatively, CCM 100 may identify the company name from a domain name of the user email address.

Event processor 144 may store other demographic information from event 108A in personal database 148, such as user job title, age, sex, geographic location (postal address), etc. In one example, some of the information in personal database 148 is hashed, such as the user ID and or any other personally identifiable information. Other information in personal database 148 may be anonymous to any specific user, such as company name and job title.

Event processor 144 builds a user intent vector 145 from topic vectors 136. Event processor 144 continuously updates user intent vector 145 based on other received events 108. For example, the search engine may display a second link to website2 in response to search query 132. User X may click on the second link and website2 may download a web page to computer 130 announcing the seminar on electric cars.

The web page downloaded by website2 also may include a CCM tag 110B. User X may register for the seminar during the web session with website2. CCM tag 110B may generate a second event 108B that includes the user ID: X, a URL link to the web page announcing the seminar, and an event type indicating the user registered for the electric car seminar advertised on the web page.

CCM tag 110B sends event 108B to CCM 100. Content analyzer 142 generates a second set of topics 136. Event 108B may contain additional personal information associated with user X. Event processor 144 may add the additional personal information to personal database 148.

Event processor 144 updates user intent vector 145 based on the second set of topics 136 identified for event 108B. Event processor 144 may add new topics to user intent vector 145 or may change the relevancy scores for existing topics. For example, topics identified in both event 108A and 108B may be assigned higher relevancy scores. Event processor 144 also may adjust relevancy scores based on the associated event type identified in events 108.

Publisher 118 may submit a search query 154 to CCM 100 via a user interface 152 on a computer 155. For example, search query 154 may ask WHO IS INTERESTED IN BUYING ELECTRIC CARS? A transporter 150 in CCM 100 searches user intent vectors 145 for electric car topics with high relevancy scores. Transporter 150 may identify user intent vector 145 for user X. Transporter 150 identifies user X and other users A, B, and C interested in electric cars in search results 156.

As mentioned above, the user IDs may be hashed and CCM 100 may not know the actual identities of users X, A, B, and C. CCM 100 may provide a segment of hashed user IDs X, A, B, and C to publisher 118 in response to query 154.

Publisher 118 may have a contact list 120 of users (FIG. 1). Publisher 118 may hash email addresses in contact list 120 and compare the hashed identifiers with the encrypted or hashed user IDs X, A, B, and C. Publisher 118 identifies the unencrypted email address for matching user identifiers. Publisher 118 then sends information related to electric cars to the email addresses of the identified user segment. For example, publisher 118 may send emails containing white papers, advertisements, articles, announcements, seminar notifications, or the like, or any combination thereof.

CCM 100 may provide other information in response to search query 154. For example, event processor 144 may aggregate user intent vectors 145 for users employed by the same company Y into a company intent vector. The company intent vector for company Y may indicate a strong interest in electric cars. Accordingly, CCM 100 may identify company Y in search results 156. By aggregating user intent vectors 145, CCM 100 can identify the intent of a company or other category without disclosing any specific user personal information, e.g., without regarding a user's online browsing activity.

CCM 100 continuously receives events 108 for different third party content. Event processor 144 may aggregate events 108 for a particular time period, such as for a current day, for the past week, or for the past 30 days. Event processor 144 then may identify trending topics 158 within that particular time period. For example, event processor 144 may identify the topics with the highest average relevancy values over the last 30 days.

Different filters 159 may be applied to the intent data stored in event database 146. For example, filters 159 may direct event processor 144 to identify users in a particular company Y that are interested in electric cars. In another example, filters 159 may direct event processor 144 to identify companies with less than 200 employees that are interested in electric cars.

Filters 159 also may direct event processor 144 to identify users with a particular job title that are interested in electric cars or identify users in a particular city that are interested in electric cars. CCM 100 may use any demographic information in personal database 148 for filtering query 154.

CCM 100 monitors content accessed from multiple different third party websites. This allows CCM 100 to better identify the current intent for a wider variety of users, companies, or any other demographics. CCM 100 may use hashed and/or other anonymous identifiers to maintain user privacy. CCM 100 further maintains user anonymity by identifying the intent of generic user segments, such as companies, marketing groups, geographic locations, or any other user demographics.

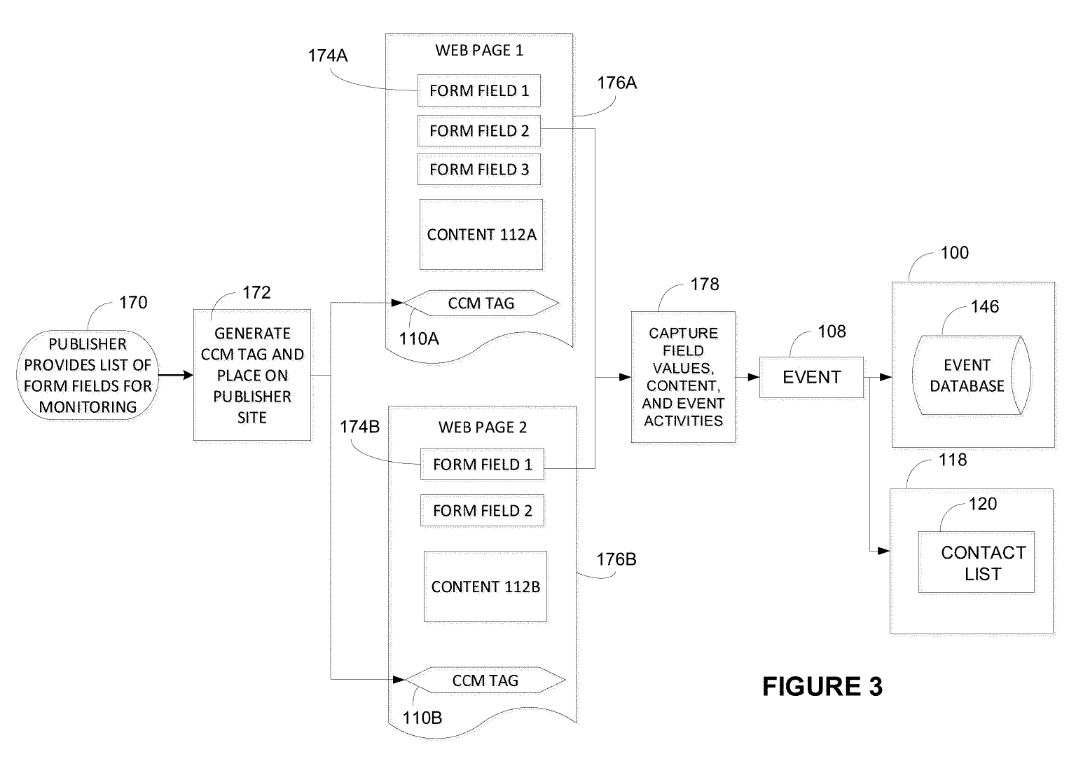

FIG. 3 depicts example operations performed by CCM tags. In operation 170, a publisher provides a list of form fields 174 for monitoring on web pages 176. In operation 172, CCM tags 110 are generated and loaded in web pages 176 on the publisher website. For example, CCM tag 110A is loaded onto a first web page 176A of the publisher website and a CCM tag 110B is loaded onto a second web page 176B of the publisher website. In one example, CCM tags 110 comprise JavaScript loaded into the web page document object model (DOM).

The publisher may download web pages 176, along with CCM tags 110, to user computers during web sessions. CCM tag 110A captures the data entered into some of form fields 174A and CCM tag 110B captures data entered into some of form fields 174B.

A user enters information into form fields 174A and 174B during the web session. For example, the user may enter an email address into one of form fields 174A during a user registration process. CCM tags 110 may capture the email address in operation 178, validate and hash the email address, and then send the hashed email address to CCM 100 in event 108.

CCM tags 100 may first confirm the email address includes a valid domain syntax and then use a hash algorithm to encode the valid email address string. CCM tags 110 also may capture other anonymous user identifiers, such as a cookie identifier. If no identifiers exist, CCM tag 110 may create a unique identifier.

CCM tags 110 may capture any information entered into fields 174. For example, CCM tags 110 also may capture user demographic data, such as company name, age, sex, postal address, etc. In one example, CCM tags 110 capture some the information for publisher contact list 120.

CCM tags 110 also may identify content 112 and associated event activities in operation 178. For example, CCM tag 110A may detect a user downloading a white paper 112A or registering for a seminar. CCM tag 110A captures the URL for white paper 112A and generates an event type identifier that identifies the event as a document download.

Depending on the application, CCM tag 110 in operation 178 sends the captured web session information in event 108 to publisher 118 or to CCM 100. For example, event 108 is sent to publisher 118 when CCM tag 110 is used for generating publisher contact list 120. Event 108 is sent to CCM 100 when CCM tag 110 is used for generating intent data.

CCM tags 110 may capture the web session information in response to the user leaving web page 176, existing one of form fields 174, selecting a submit icon, mousing out of one of form fields 174, a mouse click, an off focus, or any other user action. Note again that CCM 100 might never receive personally identifiable information (PII) since any PII data in event 108 is hashed by CCM tag 110.

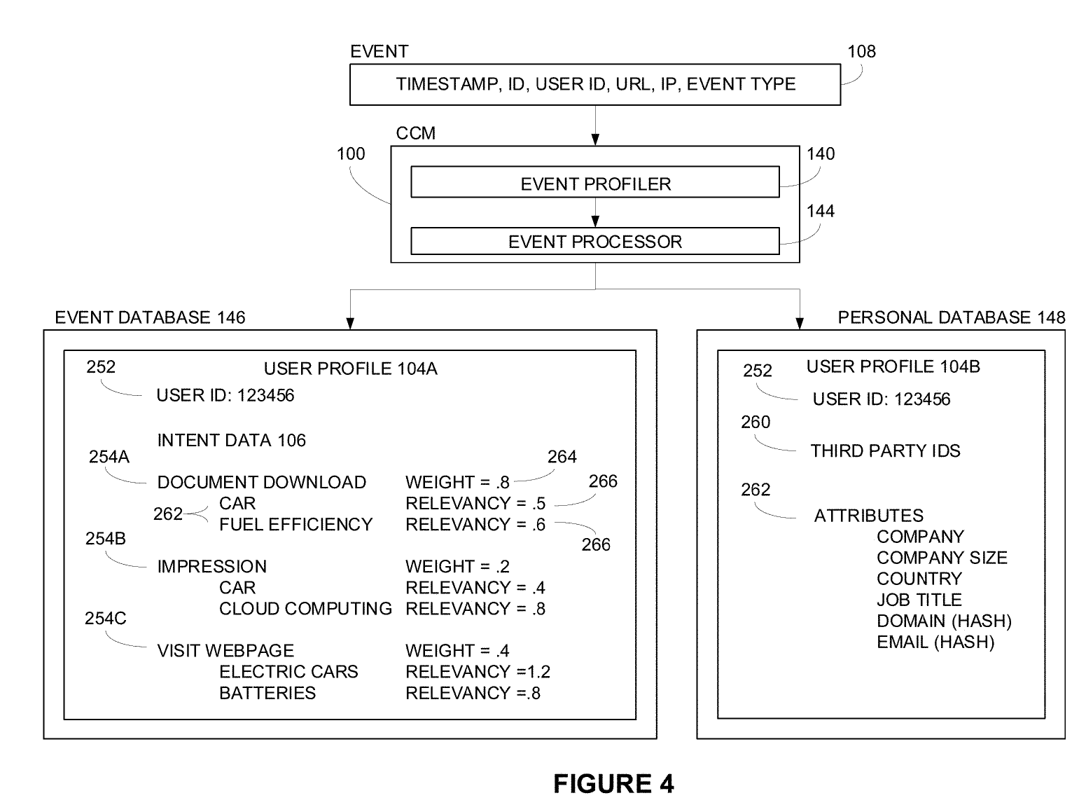

FIG. 4 is a diagram showing how the CCM generates intent data. A CCM tag may send a captured raw event 108 to CCM 100. For example, the CCM tag may send event 108 to CCM 100 in response to a user downloading a white paper. Event 108 may include a timestamp indicating when the white paper was downloaded, an identifier (ID) for event 108, a user ID associated with the user that downloaded the white paper, a URL for the downloaded white paper, and an IP address for the launching platform for the content. Event 108 also may include an event type indicating the user downloaded an electronic document.

Event profiler 140 and event processor 144 may generate intent data 106 from one or more events 108. Intent data 106 may be stored in a structured query language (SQL) database or non-SQL database. In one example, intent data 106 is stored in user profile 104A and includes a user ID 252 and associated event data 254.

Event data 254A is associated with a user downloading a white paper. Event profiler 140 identifies a car topic 262 and a fuel efficiency topic 262 in the white paper. Event profiler 140 may assign a 0.5 relevancy value to the car topic and assign a 0.6 relevancy value to the fuel efficiency topic.

Event processor 144 may assign a weight value 264 to event data 254A. Event processor 144 may assign larger a weight value 264 to more assertive events, such as downloading the white paper. Event processor 144 may assign a smaller weight value 264 to less assertive events, such as viewing a web page. Event processor 144 may assign other weight values 264 for viewing or downloading different types of media, such as downloading a text, video, audio, electronic books, on-line magazines and newspapers, etc.

CCM 100 may receive a second event 108 for a second piece of content accessed by the same user. CCM 100 generates and stores event data 254B for the second event 108 in user profile 104A. Event profiler 140 may identify a first car topic with a relevancy value of 0.4 and identify a second cloud computing topic with a relevancy value of 0.8 for the content associated with event data 254B. Event processor 144 may assign a weight value of 0.2 to event data 254B.

CCM 100 may receive a third event 108 for a third piece of content accessed by the same user. CCM 100 generates and stores event data 254C for the third event 108 in user profile 104A. Event profiler 140 identifies a first topic associated with electric cars with a relevancy value of 1.2 and identifies a second topic associated with batteries with a relevancy value of 0.8. Event processor 144 may assign a weight value of 0.4 to event data 254C.

Event data 254 and associated weighting values 264 may provide a better indicator of user interests/intent. For example, a user may complete forms on a publisher website indicating an interest in cloud computing. However, CCM 100 may receive events 108 for third party content accessed by the same user. Events 108 may indicate the user downloaded a whitepaper discussing electric cars and registered for a seminar related to electric cars.

CCM 100 generates intent data 106 based on received events 108. Relevancy values 266 in combination with weighting values 264 may indicate the user is highly interested in electric cars. Even though the user indicated an interest in cloud computing on the publisher website, CCM 100 determined from the third party content that the user was actually more interested in electric cars.

CCM 100 may store other personal user information from events 108 in user profile 104B. For example, event processor 144 may store third party identifiers 260 and attributes 262 associated with user ID 252. Third party identifiers 260 may include user names or any other identifiers used by third parties for identifying user 252. Attributes 262 may include an employer company name, company size, country, job title, hashed domain name, and/or hashed email addresses associated with user ID 252. Attributes 262 may be combined from different events 108 received from different websites accessed by the user. CCM 100 also may obtain different demographic data in user profile 104 from third party data sources (whether sourced online or offline).

An aggregator may use user profile 104 to update and/or aggregate intent data for different segments, such as publisher contact lists, companies, job titles, etc. The aggregator also may create snapshots of intent data 106 for selected time periods.

Event processor 144 may generate intent data 106 for both known and unknown users. For example, the user may access a web page and enter an email address into a form field in the web page. A CCM tag captures and hashes the email address and associates the hashed email address with user ID 252.

The user may not enter an email address into a form field. Alternatively, the CCM tag may capture an anonymous cookie ID in event 108. Event processor 144 then associates the cookie ID with user identifier 252. The user may clear the cookie or access data on a different computer. Event processor 144 may generate a different user identifier 252 and new intent data 106 for the same user.

The cookie ID may be used to create a de-identified cookie data set. The de-identified cookie data set then may be integrated with ad platforms or used for identifying destinations for target advertising.

CCM 100 may separately analyze intent data 106 for the different anonymous user IDs. If the user ever fills out a form providing an email address, event processor then may re-associate the different intent data 106 with the same user identifier 252.

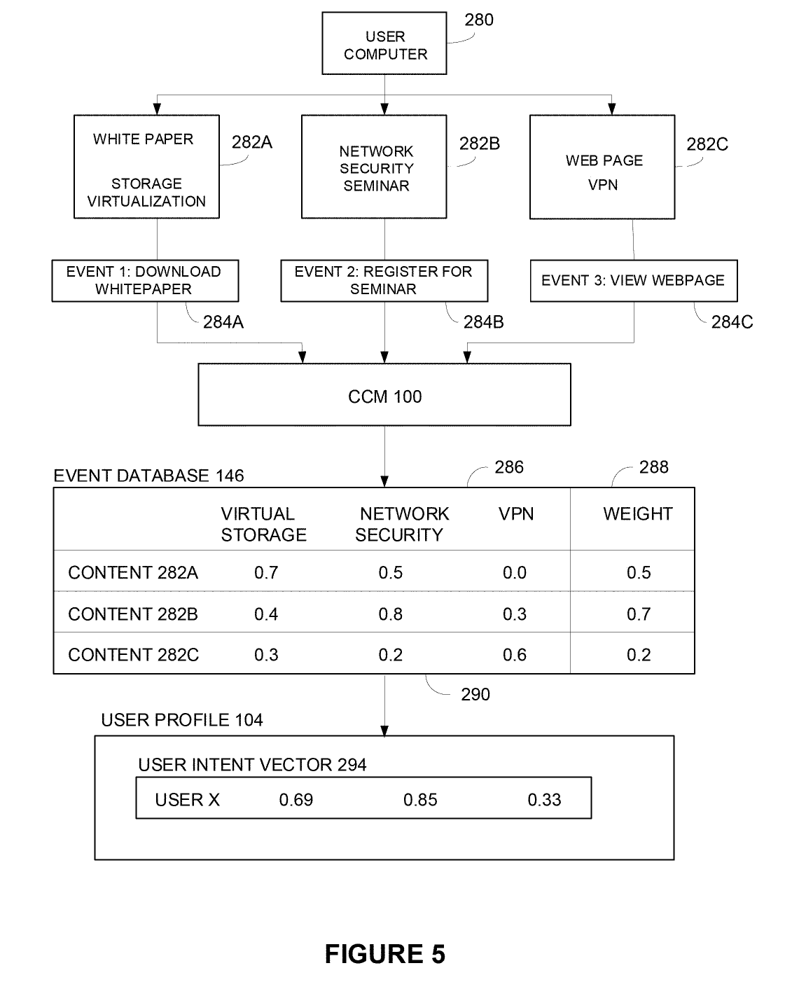

FIG. 5 depicts an example of how the CCM generates a user intent vector from the event data described above in FIG. 4. A user may use computer 280 to access different content 282. For example, the user may download a white paper 282A associated with storage virtualization, register for a network security seminar on a web page 282B, and view a web page article 282C related to virtual private networks (VPNs). Content 282A, 282B, and 282C may come from the same website or come from different websites.

The CCM tags discussed above capture three events 284A, 284B, and 284C associated with content 282A, 282B, and 282C, respectively. CCM 100 identifies topics 286 in content 282A, 282B, and/or 282C. Topics 286 include virtual storage, network security, and VPNs. CCM 100 assigns relevancy values 290 to topics 286 based on known algorithms. For example, relevancy values 290 may be assigned based on the number of times different associated keywords are identified in content 282.

CCM 100 assigns weight values 288 to content 282 based on the associated event activity. For example, CCM 100 assigns a relatively high weight value of 0.7 to a more assertive off-line activity, such as registering for the network security seminar. CCM 100 assigns a relatively low weight value of 0.2 to a more passive on-line activity, such as viewing the VPN web page.

CCM 100 generates a user intent vector 294 in user profile 104 based on the relevancy values 290. For example, CCM 100 may multiply relevancy values 290 by the associated weight values 288. CCM 100 then may sum together the weighted relevancy values for the same topics to generate user intent vector 294.

CCM 100 uses intent vector 294 to represent a user, represent content accessed by the user, represent user access activities associated with the content, and effectively represent the intent/interests of the user. In another embodiment, CCM 100 may assign each topic in user intent vector 294 a binary score of 1 or 0. CCM 100 may use other techniques for deriving user intent vector 294. For example, CCM 100 may weigh the relevancy values based on timestamps.

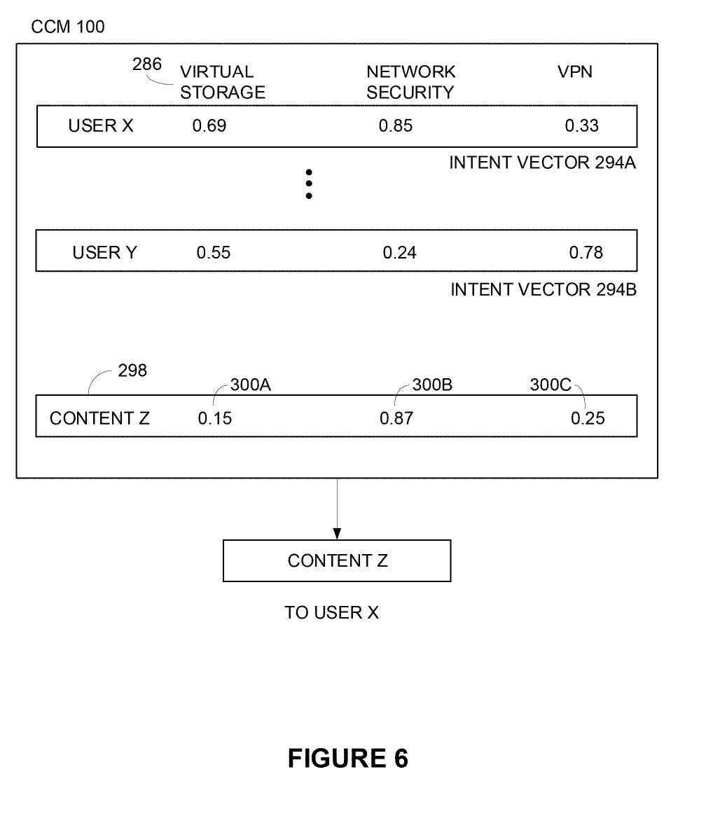

FIG. 6 depicts an example of how the CCM segments users. CCM 100 may generate user intent vectors 294A and 294B for two different users. A publisher may want to email content 298 to a segment of interested users. The publisher submits content 298 to CCM 100. CCM 100 identifies topics 286 and associated relevancy values 300 for content 298.

CCM 100 may use any variety of different algorithms to identify a segment of user intent vectors 294 associated with content 298. For example, relevancy value 300B indicates content 298 is primarily related to network security. CCM 100 may identify any user intent vectors 294 that include a network security topic with a relevancy value above a given threshold value.

In this example, assume the relevancy value threshold for the network security topic is 0.5. CCM 100 identifies user intent vector 294A as part of the segment of users satisfying the threshold value. Accordingly, CCM 100 sends the publisher of content 298 a contact segment that includes the user ID associated with user intent vector 294A. As mentioned above, the user ID may be a hashed email address, cookie ID, or some other encrypted or unencrypted identifier associated with the user.

In another example, CCM 100 calculates vector cross products between user intent vectors 294 and content 298. Any user intent vectors 294 that generate a cross product value above a given threshold value are identified by CCM 100 and sent to the publisher.

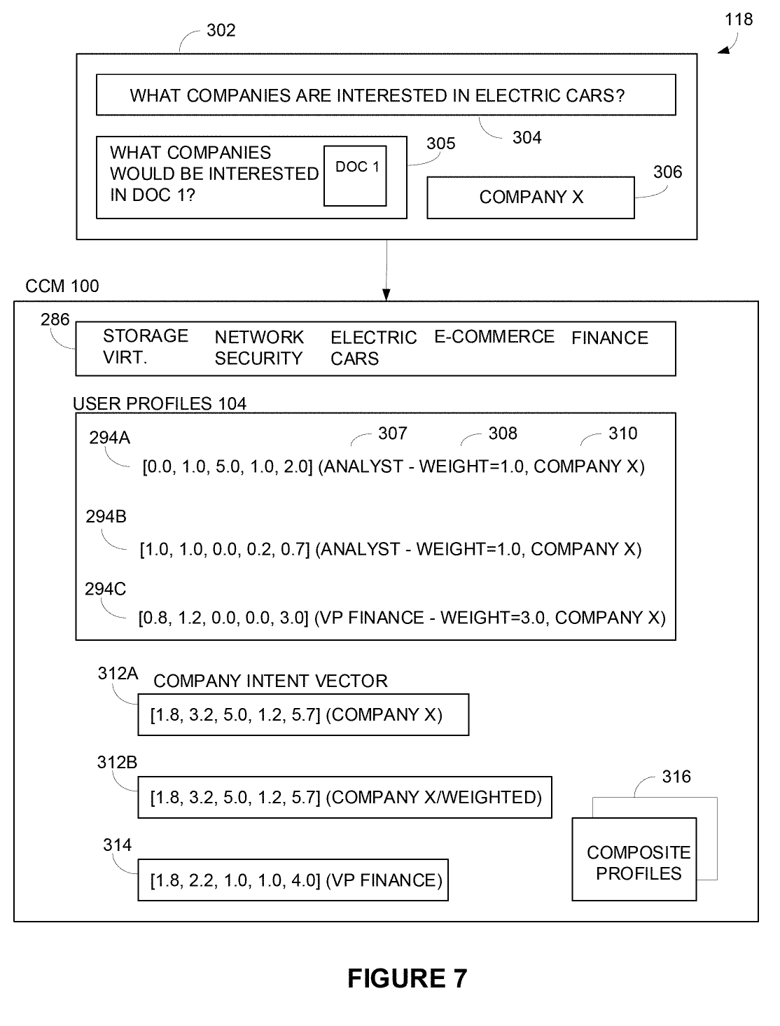

FIG. 7 depicts examples of how the CCM aggregates intent data. In this example, a publisher operating a computer 302 submits a search query 304 to CCM 100 asking what companies are interested in electric cars. In this example, CCM 100 associates five different topics 286 with user profiles 104. Topics 286 include storage virtualization, network security, electric cars, e-commerce, and finance.

CCM 100 generates user intent vectors 294 as described above in FIG. 6. User intent vectors 294 have associated personal information, such as a job title 307 and an employer company name 310. As explained above, users may provide personal information, such as employer name and job title in form fields when accessing a publisher or third party website.

The CCM tags described above capture and send the job title and employer name information to CCM 100. CCM 100 stores the job title and employer information in the associated user profile 104.

CCM 100 searches user profiles 104 and identifies three user intent vectors 294A, 294B, and 294C associated with the same employer name 310. CCM 100 determines that user intent vectors 294A and 294B are associated with a same job title of analyst and user intent vector 294C is associated with a job title of VP of finance.

In response to, or prior to, search query 304, CCM 100 generates a company intent vector 312A for company X. CCM 100 may generate company intent vector 312A by summing up the topic relevancy values for all of the user intent vectors 294 associated with company X.

In response to search query 304, CCM 100 identifies any company intent vectors 312 that include an electric car topic 286 with a relevancy value greater than a given threshold. For example, CCM 100 may identify any companies with relevancy values greater than 4.0. In this example, CCM 100 identifies company X in search results 306.

In one example, intent is identified for a company at a particular zip code, such as zip code 11201. CCM 100 may take customer supplied offline data, such as from a Customer Relationship Management (CRM) database, and identify the users that match the company and zip code 11201 to create a segment.

In another example, publisher 118 may enter a query 305 asking which companies are interested in a document (DOC 1) related to electric cars. Computer 302 submits query 305 and DOC 1 to CCM 100. CCM 100 generates a topic vector for DOC 1 and compares the DOC 1 topic vector with all known company intent vectors 312A.

CCM 100 may identify an electric car topic in the DOC 1 with high relevancy value and identify company intent vectors 312 with an electric car relevancy value above a given threshold. In another example, CCM 100 may perform a vector cross product between the DOC 1 topics and different company intent vectors 312. CCM 100 may identify the names of any companies with vector cross product values above a given threshold value and display the identified company names in search results 306.

CCM 100 may assign weight values 308 for different job titles. For example, an analyst may be assigned a weight value of 1.0 and a vice president (VP) may be assigned a weight value of 3.0. Weight values 308 may reflect purchasing authority associated with job titles 307. For example, a VP of finance may have higher authority for purchasing electric cars than an analyst. Weight values 308 may vary based on the relevance of the job title to the particular topic. For example, CCM 100 may assign an analyst a higher weight value 308 for research topics.

CCM 100 may generate a weighted company intent vector 312B based on weighting values 308. For example, CCM 100 may multiply the relevancy values for user intent vectors 294A and 294B by weighting value 1.0 and multiply the relevancy values for user intent vector 294C by weighting value 3.0. The weighted topic relevancy values for user intent vectors 294A, 294B, and 294C are then summed together to generate weighted company intent vector 312B.

CCM 100 may aggregate together intent vectors for other categories, such as job title. For example, CCM 100 may aggregate together all the user intent vectors 294 with VP of finance job titles into a VP of finance intent vector 314. Intent vector 314 identifies the topics of interest to VPs of finance.

CCM 100 also may perform searches based on job title or any other category. For example, publisher 118 may enter a query LIST VPs OF FINANCE INTERESTED IN ELECTRIC CARS? The CCM 100 identifies all of the user intent vectors 294 with associated VP finance job titles 307. CCM 100 then segments the group of user intent vectors 294 with electric car topic relevancy values above a given threshold value.

CCM 100 may generate composite profiles 316. Composite profiles 316 may contain specific information provided by a particular publisher or entity. For example, a first publisher may identify a user as VP of finance and a second publisher may identify the same user as VP of engineering. Composite profiles 316 may include other publisher provided information, such as company size, company location, company domain.

CCM 100 may use a first composite profile 316 when providing user segmentation for the first publisher. The first composite profile 316 may identify the user job title as VP of finance. CCM 100 may use a second composite profile 316 when providing user segmentation for the second publisher. The second composite profile 316 may identify the job title for the same user as VP of engineering. Composite profiles 316 are used in conjunction with user profiles 104 derived from other third party content.

In yet another example, CCM 100 may segment users based on event type. For example, CCM 100 may identify all the users that downloaded a particular article, or identify all of the users from a particular company that registered for a particular seminar.

### Consumption Scoring

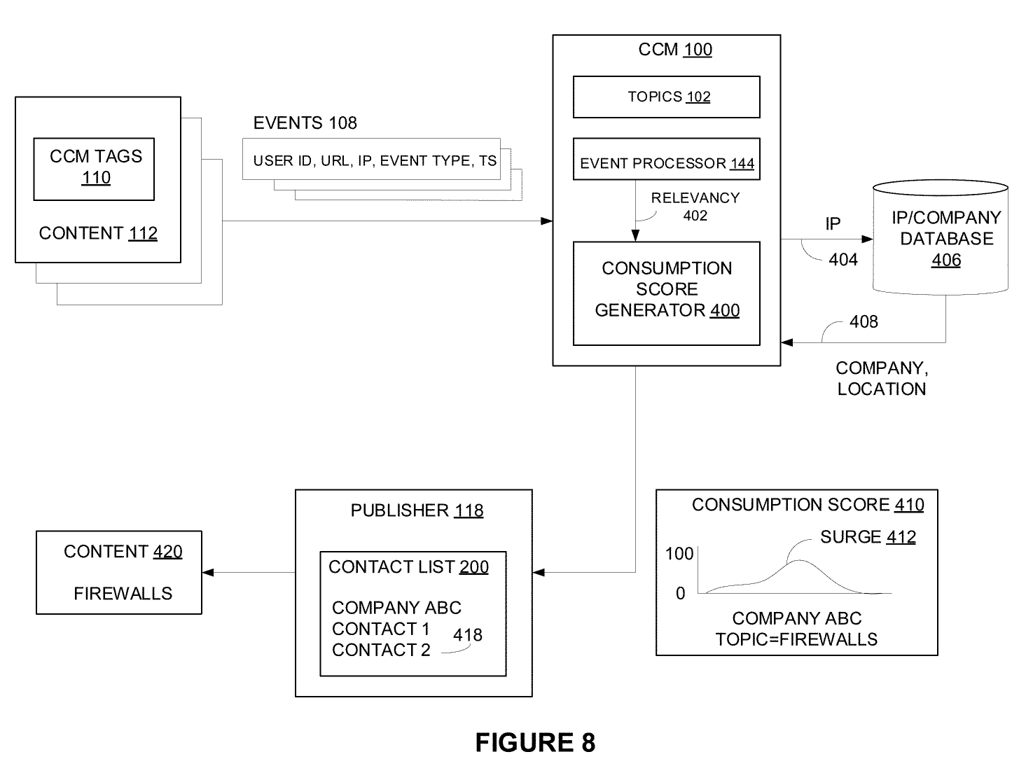

FIG. 8 depicts an example consumption score generator used in CCM 100. As explained above, CCM 100 may receive multiple events 108 associated with different content 112. For example, users may access web browsers, or any other application, to view content 112 on different websites. Content 112 may include any webpage, document, article, advertisement, or any other information viewable or audible by a user. For example, content 112 may include a webpage article or a document related to network firewalls.

CCM tag 110 may capture events 108 identifying content 112 accessed by a user during the web or application session. For example, events 108 may include a user identifier (USER ID), URL, IP address, event type, and time stamp (TS).

The user identifier may be a unique identifier CCM tag 110 generates for a specific user on a specific browser. The URL may be a link to content 112 accessed by the user during the web session. The IP address may be for a network device used by the user to access the Internet and content 112. As explained above, the event type may identify an action or activity associated with content 112. For example, the event type may indicate the user downloaded an electric document or displayed a webpage. The timestamp (TS) may identify a day and time the user accessed content 112.

Consumption score generator (CSG) 400 may access a IP/company database 406 to identify a company/entity and location 408 associated with IP address 404 in event 108. For example, existing services may provide databases 406 that identify the company and company address associated with IP addresses. The IP address and/or associated company or entity may be referred to generally as a domain. CSG 400 may generate metrics from events 108 for the different the companies 408 identified in database 406.

In another example, CCM tags 110 may include domain names in events 108. For example, a user may enter an email address into a web page field during a web session. CCM 100 may hash the email address or strip out the email domain address. CCM 100 may use the domain name to identify a particular company and location 408 from database 406.

As also described above, event processor 144 may generate relevancy scores 402 that indicate the relevancy of content 112 with different topics 102. For example, content 112 may include multiple words associate with topics 102. Event processor 144 may calculate relevancy scores 402 for content 112 based on the number and position words associated with a selected topic.

CSG 400 may calculate metrics from events 108 for particular companies 408. For example, CSG 400 may identify a group of events 108 for a current week that include the same IP address 404 associated with a same company and company location 408. CSG 400 may calculate a consumption score 410 for company 408 based on an average relevancy score 402 for the group of events 108. CSG 400 also may adjust the consumption score 410 based on the number of events 108 and the number of unique users generating the events 108.

CSG 400 may generate consumption scores 410 for company 408 for a series of time periods. CSG 400 may identify a surge 412 in consumption scores 410 based on changes in consumption scores 410 over a series of time periods. For example, CSG 400 may identify surge 412 based on changes in content relevancy, number of unique users, and number of events over several weeks. It has been discovered that surge 412 may correspond with a unique period when companies have heightened interest in a particular topic and are more likely to engage in direct solicitations related to that topic.

CCM 100 may send consumption scores 410 and/or any surge indicators 412 to publisher 118. Publisher 118 may store a contact list 200 that includes contacts 418 for company ABC. For example, contact list 200 may include email addresses or phone number for employees of company ABC. Publisher 118 may obtain contact list 200 from any source such as from a customer relationship management (CRM) system, commercial contact lists, personal contacts, third parties lead services, retail outlets, promotions or points of sale, or the like or any combination thereof.

In one example, CCM 100 may send weekly consumption scores 410 to publisher 118. In another example, publisher 118 may have CCM 100 only send surge notices 412 for companies on list 200 surging for particular topics 102.

Publisher 118 may send content 420 related to surge topics to contacts 418. For example, publisher 118 may send email advertisements, literature, or banner ads related to a firewalls to contacts 418. Alternatively, publisher 118 may call or send direct mailings regarding firewalls to contacts 418. Since CCM 100 identified surge 412 for a firewall topic at company ABC, contacts 418 at company ABC are more likely to be interested in reading and/or responding to content 420 related to firewalls. Thus, content 420 is more likely to have a higher impact and conversion rate when sent to contacts 418 of company ABC during surge 412.

In another example, publisher 118 may sell a particular product, such as firewalls. Publisher 118 may have a list of contacts 418 at company ABC known to be involved with purchasing firewall equipment. For example, contacts 418 may include the chief technology officer (CTO) and information technology (IT) manager at company ABC. CCM 100 may send publisher 118 a notification whenever a surge 412 is detected for firewalls at company ABC. Publisher 118 then may automatically send content 420 to specific contacts 418 at company ABC with job titles most likely to be interested in firewalls.

CCM 100 also may use consumption scores 410 for advertising verification. For example, CCM 100 may compare consumption scores 410 with advertising content 420 sent to companies or individuals. Advertising content 420 with a particular topic sent to companies or individuals with a high consumption score or surge for that same topic may receive higher advertising rates.

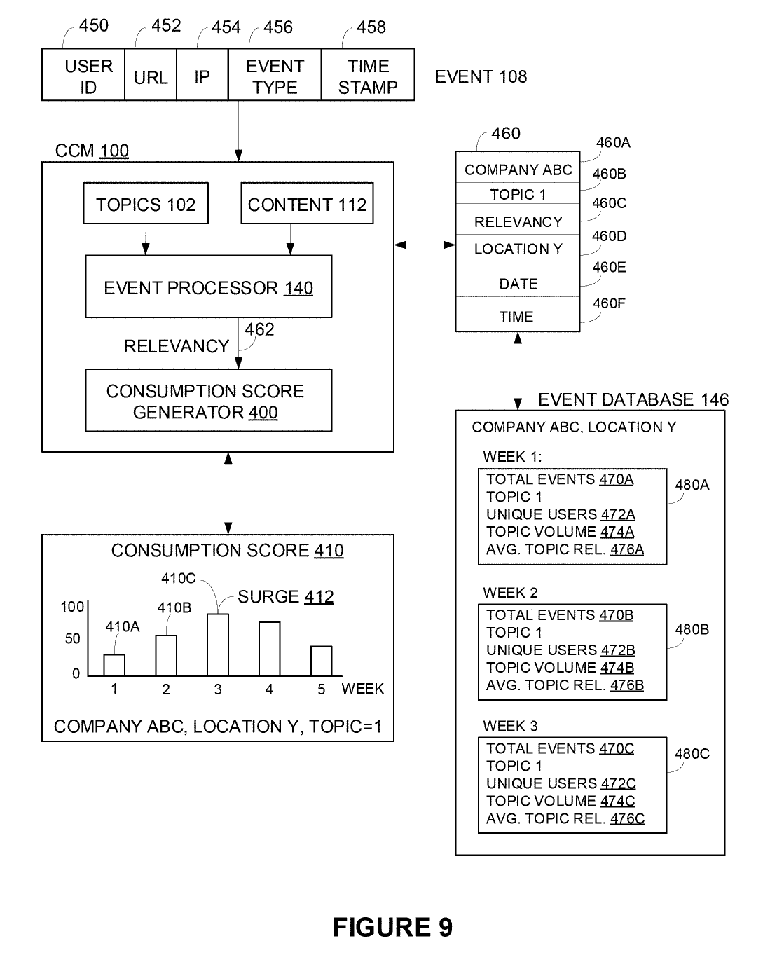

FIG. 9 shows in more detail how CCM 100 generates consumption scores 410. CCM 100 may receive millions of events from millions of different users associated with thousands of different domains every day. CCM 100 may accumulate the events 108 for different time periods, such as for each week. Week time periods are just one example and CCM 100 may accumulate events 108 for any selectable time period. CCM 100 also may store a set of topics 102 for any selectable subject matter. CCM 100 also may dynamically generate some of topics 102 based on the content identified in events 108 as described above.

Events 108 as mentioned above may include a user ID 450, URL 452, IP address 454, event type 456, and time stamp 458. Event processor 140 may identify content 112 located at URL 542 and select one of topics 102 for comparing with content 112. Event processor 140 may generate an associated relevancy score 462 indicating the relevancy of content 112 to selected topic 102. Relevancy score 462 may alternatively be referred to as a topic score.

CSG 400 may generate consumption data 460 from events 108. For example, CSG 400 may identify a company 460A associated with IP address 454. CSG 400 also may calculate a relevancy score 460C between content 112 and the selected topic 460B. CSG 400 also may identify a location 460D for with company 460A and identify a date 460E and time 460F when event 108 was detected.

CSG 400 may generate consumption metrics 480 from consumption data 460. For example, CSG 400 may calculate a total number of events 470A associated with company 460A (company ABC) and location 460D (location Y) for all topics during a first time period, such as for a first week. CSG 400 also may calculate the number of unique users 472A generating the events 108 associated with company ABC and topic 460B for the first week. CSG 400 may calculate for the first week a total number of events generated by company ABC for topic 460B (topic volume 474A). CSG 400 also may calculate an average topic relevancy 476A for the content accessed by company ABC and associated with topic 460B. CSG 400 may generate consumption metrics 480A-480C for sequential time periods, such as for three consecutive weeks.

CSG 400 may generate consumption scores 410 based on consumption metrics 480A-480C. For example, CSG 400 may generate a first consumption score 410A for week 1 and generate a second consumption score 410B for week 2 based in part on changes between consumption metrics 480A for week 1 and consumption metrics 480B for week 2. CSG 400 may generate a third consumption score 410C for week 3 based in part on changes between consumption metrics 480A, 480B, and 480C for weeks 1, 2, and 3, respectively. In one example, any consumption score 410 above as threshold value is identified as a surge 412.

CSG 400 may weight relevancy scores 462 based on the content source. For example, some content 112 may be accessed from a website operated by a selected publisher 118 that sells firewalls. CSG 400 may generate customized consumption scores 410 for the selected publisher 118. The customized consumption scores 410 may more accurately identify topics associated with a particular publisher 118 that are of particular interest to company 460A.

For example, some users from company 460A may download content 112, such as webpages, from a website of the selected publisher 118. CSG 400 may calculate relevancy scores 460C of content 112 for selected topics 460B. CSG 400 may increase relevancy scores 460C for content 112 accessed from the website of the selected publisher 118 or may weight relevancy scores 460C for the publisher related content 112 higher than relevancy scores 460C for other content 112. CSG 400 then averages the relevancy scores 460C for the selected publisher content 112 with relevancy scores 460C for the other content 112 to derive an average topic relevancy 476 weighted for the selected publisher 118.

CSG 400 then may generate a custom consumption score 410 based on the weighted average topic relevancy 476, or on any other publisher weighted metric. For example, CSG 400 may calculate the total number of events 470A associated with company 460A (company ABC) at location 460D (location Y) for all topics during a first time period, such as for a first week. CSG 400 may apply a higher weighting to the events 470A associated with the selected publisher 118. For example, CSG 400 may count every event 108 generated from the selected publisher website as two events.

CSG 400 also may weight the number of unique users 472 generating events 108 associated with company ABC and topic 460B for the first week. For example, CSG 400 may double count unique users 472 or topic volume 474 for content 112 from the website of the specified publisher 118. CSG 400 then generates customized consumption scores 410 based on the publisher weighted consumption metrics 480A-480C. CCM 100 supplies the customized consumption scores 410 and any related surge information 412 to the selected publisher 118.

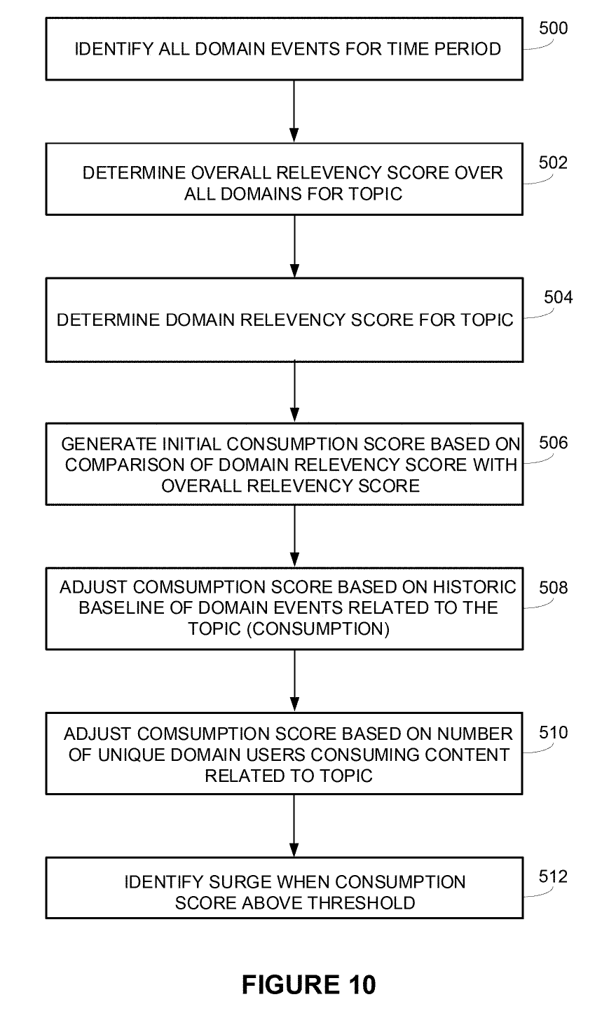

FIG. 10 depicts a process for identifying a surge in consumption scores. In operation 500, the CCM may identify all domain events for a given time period. For example, for a current week the CCM may accumulate all of the events for every IP address (domain) associated with every topic.

The CCM may use thresholds to select which domains to generate consumption scores. For example, for the current week the CCM may count the total number of events for a particular domain (domain level event count (DEC)) and count the total number of events for the domain at a particular location (metro level event count (DMEC)).

The CCM may calculate the consumption score for domains with a number of events more than a threshold (DEC>threshold). The threshold can vary based on the number of domains and the number of events. The CCM may use the second DMEC threshold to determine when to generate separate consumption scores for different domain locations. For example, the CCM may separate subgroups of company ABC events for the cities of Atlanta, New York, and Los Angeles that have each a number events DMEC above the second threshold.

In operation 502, the CCM may determine an overall relevancy score for all selected domains for each of the topics. For example, the CCM for the current week may calculate an overall average relevancy score for all domain events associated with the firewall topic.

In operation 504, the CCM may determine a relevancy score for a specific domain. For example, the CCM may identify a group of events having a same IP address associated with company ABC. The CCM may calculate an average domain relevancy score for the company ABC events associated with the firewall topic.

In operation 506, the CCM may generate an initial consumption score based on a comparison of the domain relevancy score with the overall relevancy score. For example, the CCM may assign an initial low consumption score when the domain relevancy score is a certain amount less than the overall relevancy score. The CCM may assign an initial medium consumption score larger than the low consumption score when the domain relevancy score is around the same value as the overall relevancy score. The CCM may assign an initial high consumption score larger than the medium consumption score when the domain relevancy score is a certain amount greater than the overall relevancy score. This is just one example, and the CCM may use any other type of comparison to determine the initial consumption scores for a domain/topic.

In operation 508, the CCM may adjust the consumption score based on a historic baseline of domain events related to the topic. This is alternatively referred to as consumption. For example, the CCM may calculate the number of domain events for company ABC associated with the firewall topic for several previous weeks.

The CCM may reduce the current week consumption score based on changes in the number of domain events over the previous weeks. For example, the CCM may reduce the initial consumption score when the number domain events fall in the current week and may not reduce the initial consumption score when the number of domain events rises in the current week.

In operation 510, the CCM may further adjust the consumption score based on the number of unique users consuming content associated with the topic. For example, the CCM for the current week may count the number of unique user IDs (unique users) for company ABC events associated with firewalls. The CCM may not reduce the initial consumption score when the number of unique users for firewall events increases from the prior week and may reduce the initial consumption score when the number of unique users drops from the previous week.

In operation 512, the CCM may identify surges based on the adjusted weekly consumption score. For example, the CCM may identify a surge when the adjusted consumption score is above a threshold.

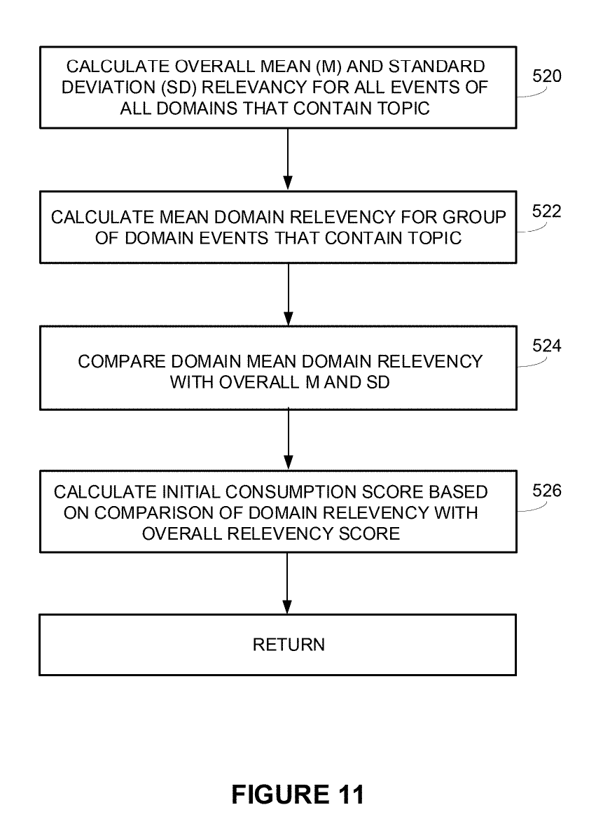

FIG. 11 depicts in more detail the process for generating an initial consumption score. It should be understood this is just one example scheme and a variety of other schemes also may be used.

In operation 520, the CCM may calculate an arithmetic mean (M) and standard deviation (SD) for each topic over all domains. The CCM may calculate M and SD either for all events for all domains that contain the topic, or alternatively for some representative (big enough) subset of the events that contain the topic. The CCM may calculate the overall mean and standard deviation as follows:

$$Mean \text{:} M = \frac{1}{n} * {\sum }_{1}^{n} {x}_{i}$$

$$Standard deviation \text{:} SD = \sqrt{\frac{1}{n - 1}} {\sum }_{1}^{n} {( {x}_{i} - M )}^{2}$$

Where xᵢ is a topic relevancy and n is a total number of events.

In operation 522, the CCM may calculate a mean (average) domain relevancy for each group of domain and/or domain/metro events for each topic. For example, for the past week the CCM may calculate the average relevancy for company ABC events for firewalls.

In operation 524, the CCM may compare the domain mean relevancy with the overall mean (M) relevancy and over standard deviation (SD) relevancy for all domains. For example, the CMM may assign three different levels to the domain mean relevancy (DMR).
Low: DMR<M−0.5*SD ˜33% of all values
Medium: M−0.5*SD<DMR<M+0.5*SD ˜33% of all values
High: DMR>M+0.5*SD ˜33% of all values

In operation 526, the CCM may calculate an initial consumption score for the domain/topic based on the above relevancy levels. For example, for the current week the CCM may assign one of the following initial consumption scores to the company ABC firewall topic. Again, this just one example of how the CCM may assign an initial consumption score to a domain/topic.
Relevancy=High: initial consumption score=100
Relevancy=Medium: Initial consumption score=70
Relevancy=Low: Initial consumption score 40.

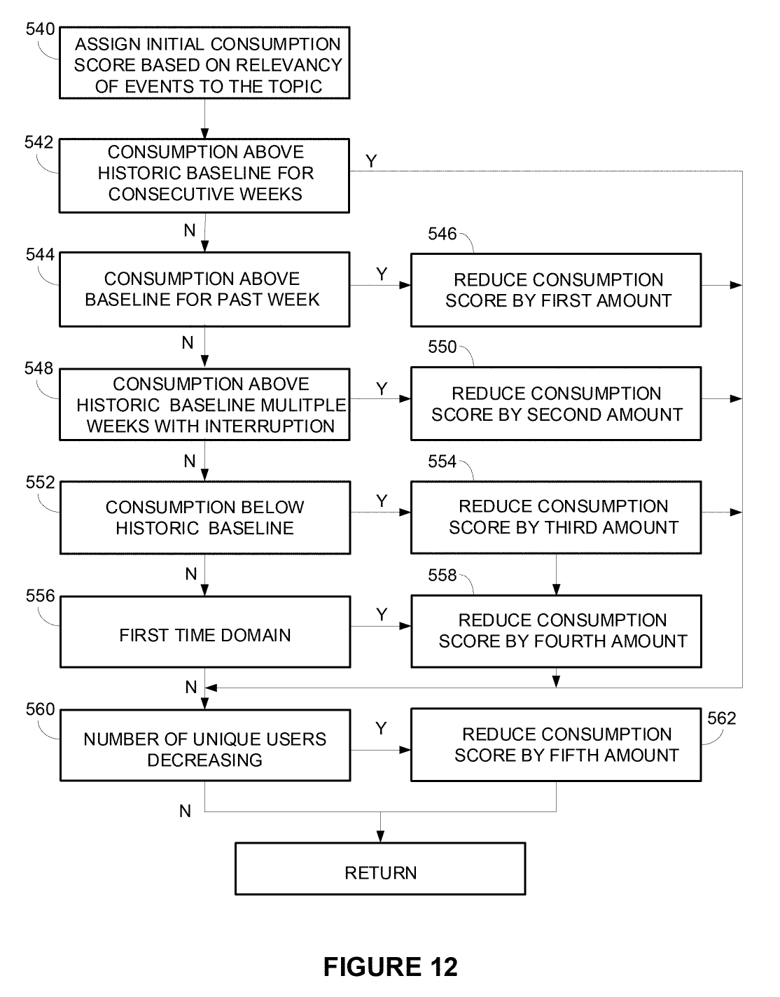

FIG. 12 depicts one example of how the CCM may adjust the initial consumption score. These are also just examples and the CCM may use other schemes for calculating a final consumption score. In operation 540, the CCM may assign an initial consumption score to the domain/location/topic as described above in FIG. 11.

The CCM may calculate a number of events for domain/location/topic for a current week. The number of events is alternatively referred to as consumption. The CCM also may calculate the number of domain/location/topic events for previous weeks and adjust the initial consumption score based on the comparison of current week consumption with consumption for previous weeks.

In operation 542, the CCM may determine if consumption for the current week is above historic baseline consumption for previous consecutive weeks. For example, the CCM may determine is the number of domain/location/topic events for the current week is higher than an average number of domain/location/topic events for at least the previous two weeks. If so, the CCM may not reduce the initial consumption value derived in FIG. 11.

If the current consumption is not higher than the average consumption in operation 542, the CCM in operation 544 may determine if the current consumption is above a historic baseline for the previous week. For example, the CCM may determine if the number of domain/location/topic events for current week is higher than the average number of domain/location/topic events for the previous week. If so, the CCM in operation 546 may reduce the initial consumption score by a first amount.

If the current consumption is not above than the previous week consumption in operation 544, the CCM in operation 548 may determine if the current consumption is above the historic consumption baseline but with interruption. For example, the CCM may determine if the number of domain/location/topic events has fallen and then risen over recent weeks. If so, the CCM in operation 550 may reduce the initial consumption score by a second amount.

If the current consumption is not above than the historic interrupted baseline in operation 548, the CCM in operation 552 may determine if the consumption is below the historic consumption baseline. For example, the CCM may determine if the current number of domain/location/topic events is lower than the previous week. If so, the CCM in operation 554 may reduce the initial consumption score by a third amount.

If the current consumption is above the historic base line in operation 552, the CCM in operation 556 may determine if the consumption is for a first time domain. For example, the CCM may determine the consumption score is being calculated for a new company or for a company that did not previously have enough events to qualify for calculating a consumption score. If so, the CCM in operation 558 may reduce the initial consumption score by a fourth amount.

In one example, the CCM may reduce the initial consumption score by the following amounts. This of course is just an example and the CCM may use any values and factors to adjust the consumption score.
Consumption above historic baseline consecutive weeks (operation 542).—0
Consumption above historic baseline past week (operation 544).—20 (first amount).
Consumption above historic baseline for multiple weeks with interruption (operation 548)—30 (second amount).
Consumption below historic baseline (operation 552).—40 (third amount).
First time domain (domain/metro) observed (operation 556).—30 (fourth amount).

As explained above, the CCM also may adjust the initial consumption score based on the number of unique users. The CCM tags 110 in FIG. 8 may include cookies placed in web browsers that have unique identifiers. The cookies may assign the unique identifiers to the events captured on the web browser. Therefore, each unique identifier may generally represent a web browser for a unique user. The CCM may identify the number of unique identifiers for the domain/location/topic as the number of unique users. The number of unique users may provide an indication of the number of different domain users interested in the topic.

In operation 560, the CCM may compare the number of unique users for the domain/location/topic for the current week with the number of unique users for the previous week. The CCM may not reduce the consumption score if the number of unique users increases over the previous week. When the number of unique users decrease, the CCM in operation 562 may further reduce the consumption score by a fifth amount. For example, the CCM may reduce the consumption score by 10.

The CCM may normalize the consumption score for slower event days, such as weekends. Again, the CCM may use different time periods for generating the consumption scores, such as each month, week, day, hour, etc. The consumption scores above a threshold are identified as a surge or spike and may represent a velocity or acceleration in the interest of a company or individual in a particular topic. The surge may indicate the company or individual is more likely to engage with a publisher who presents content similar to the surge topic.

### Consumption DNA

One advantage of domain based surge detection is that a surge can be identified for a company without using personally identifiable information (PII) of the company employees. The CCM derives the surge data based on a company IP address without using PII associated with the users generating the events.

In another example, the user may provide PII information during web sessions. For example, the user may agree to enter their email address into a form prior to accessing content. As described above, the CCM may hash the PII information and include the encrypted PII information either with company consumption scores or with individual consumption scores.

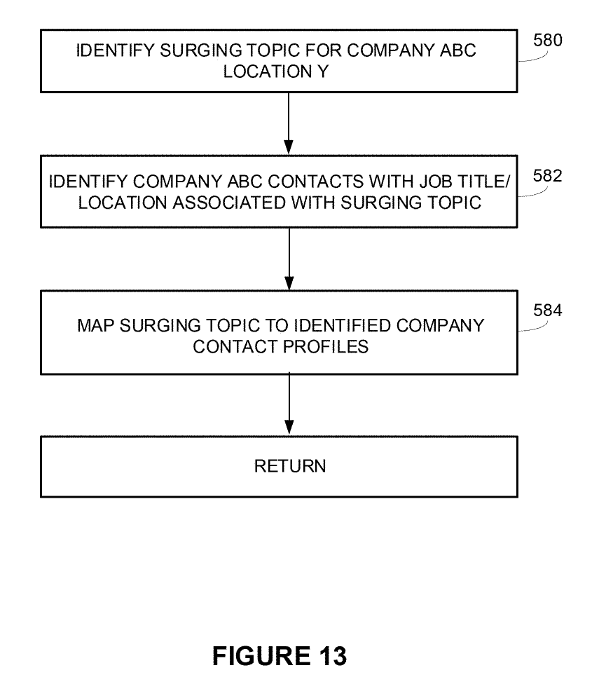

FIG. 13 shows one example process for mapping domain consumption data to individuals. In operation 580, the CCM may identify a surging topic for company ABC at location Y as described above. For example, the CCM may identify a surge for company ABC in New York for firewalls.

In operation 582, the CCM may identify users associated with company ABC. As mentioned above, some employees at company ABC may have entered personal contact information, including their office location\ and/or job titles into fields of web pages during events 108. In another example, a publisher or other party may obtain contact information for employees of company ABC from CRM customer profiles or third party lists.

Either way, the CCM or publisher may obtain a list of employees/users associated with company ABC at location Y. The list also may include job titles and locations for some of the employees/users. The CCM or publisher may compare the surge topic with the employee job titles. For example, the CCM or publisher may determine that the surging firewall topic is mostly relevant to users with a job title such as engineer, chief technical officer (CTO), or information technology (IT).

In operation 584, the CCM or publisher maps the surging firewall topic to profiles of the identified employees of company ABC. In another example, the CCM or publisher may not be as discretionary and map the firewall surge to any user associated with company ABC. The CCM or publisher then may direct content associated with the surging topic to the identified users. For example, the publisher may direct banner ads or emails for firewall seminars, products, and/or services to the identified users.

Consumption data identified for individual users is alternatively referred to as Dino DNA and the general domain consumption data is alternatively referred to as frog DNA. Associating domain consumption and surge data with individual users associated with the domain may increase conversion rates by providing more direct contact to users more likely interested in the topic.

### Intent Measurement

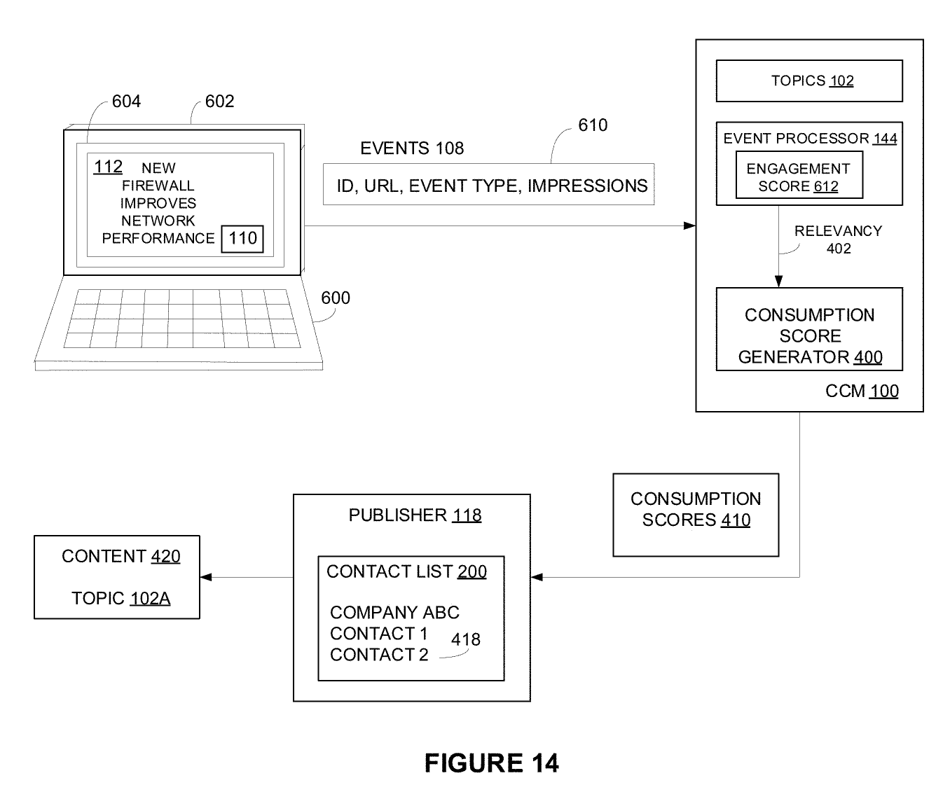

FIG. 14 depicts how CCM 100 may calculate consumption scores based on user engagement. A computer 600 may comprise a laptop, smart phone, tablet or any other device for accessing content 112. In this example, a user may open a web browser 604 on a screen 602 of computer 600. CCM tag 110 may operate within web browser 604 and monitor user web sessions. As explained above, CCM tag 110 may generate events 108 for the web session that include an identifier (ID), a URL for content 112, and an event type that identifies an action or activity associated with content 112. For example, CCM tag 110 may add an event type identifier into event 108 indicating the user downloaded an electric document.

In one example, CCM tag 110 also may generate a set of impressions 610 indicating actions taken by the user while viewing content 112. For example, impressions 610 may indicate how long the user dwelled on content 112 and/or how the user scrolled through content 112. Impressions 610 may indicate a level of engagement or interest the user has in content 112. For example, the user may spend more time on the web page and scroll through web page at a slower speed when the user is more interested in the content 112.

CCM 100 may calculate an engagement score 612 for content 112 based on impressions 610. CCM 100 may use engagement score 612 to adjust a relevancy score 402 for content 112. For example, CCM 100 may calculate a larger engagement score 612 when the user spends a larger amount of time carefully paging through content 112. CCM 100 then may increase relevancy score 402 of content 112 based on the larger engagement score 612. CSG 400 may adjust consumption scores 410 based on the increased relevancy 402 to more accurately identify domain surge topics. For example, a larger engagement score 612 may produce a larger relevancy 402 that produces a larger consumption score 410.

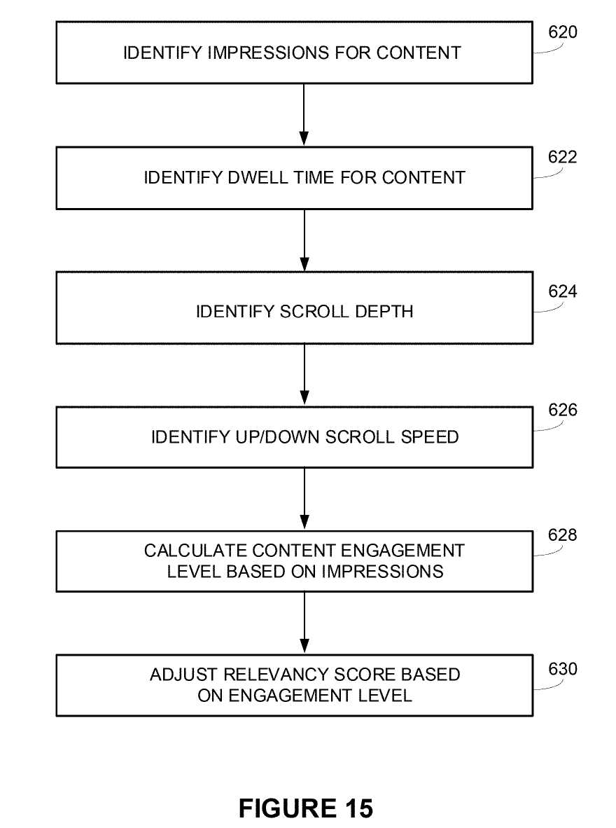

FIG. 15 depicts an example process for calculating the engagement score for content. In operation 620, the CCM may receive events that include content impressions. For example, the impressions may indicate any user interaction with content including tab selections that switch to different pages, page movements, mouse page scrolls, mouse clicks, mouse movements, scroll bar page scrolls, keyboard page movements, touch screen page scrolls, or any other content movement or content display indicator.

In operation 622, the CCM may identify the content dwell time. The dwell time may indicate how long the user actively views a page of content. In one example, tag 110 may stop a dwell time counter when the user changes page tabs or becomes inactive on a page. Tag 110 may start the dwell time counter again when the user starts scrolling with a mouse or starts tabbing.

In operation 624, the CCM may identify from the events a scroll depth for the content. For example, the CCM may determine how much of a page the user scrolled through or reviewed. In one example, the CCM tag or CCM may convert a pixel count on the screen into a percentage of the page.

In operation 626, the CCM may identify an up/down scroll speed. For example, dragging a scroll bar may correspond with a fast scroll speed and indicate the user has less interest in the content. Using a mouse wheel to scroll through content may correspond with a slower scroll speed and indicate the user is more interested in the content.

The CCM may assign higher values to impressions that indicate a higher user interest and assign lower values to impressions that indicate lower user interest. For example, the CCM may assign a larger value in operation 622 when the user spends more time actively dwelling on a page and may assign a smaller value when the user spends less time actively dwelling on a page.

In operation 628, the CCM may calculate the content engagement score based on the values derived in operations 622-628. For example, the CCM may add together and normalize the different values derived in operations 622-628.

In operation 630, the CCM may adjust content relevancy values described above in FIGS. 1-7 based on the content engagement score. For example, the CCM may increase the relevancy value when the content has a high engagement score and decrease the relevancy for a lower engagement score.

CCM 100 or CCM tag 110 in FIG. 14 may adjust the values assigned in operations 622-626 based on the type of device 600 used for viewing the content. For example, the dwell times, scroll depths, and scroll speeds, may vary between smart phone, tablets, laptops and desktop computers. CCM 100 or tag 110 may normalize or scale the impression values so different devices provide similar relative user engagement results.

### IP Address Classification

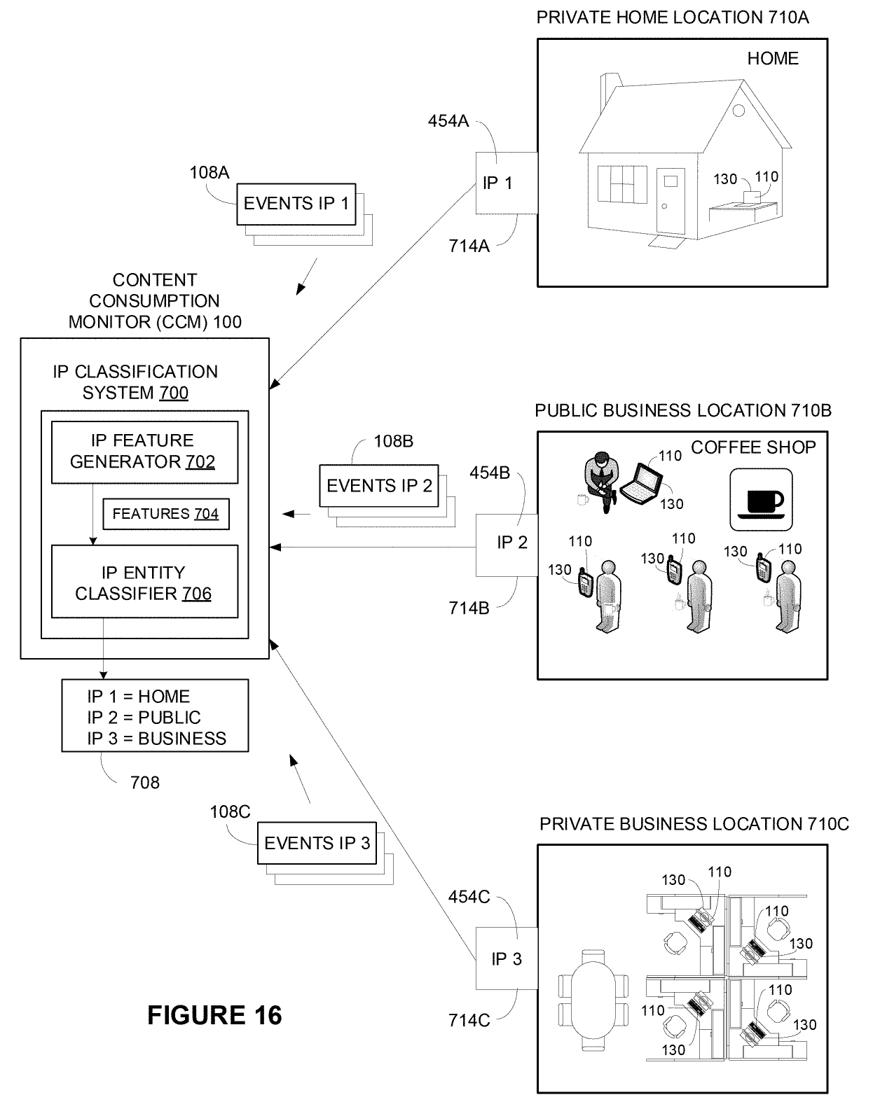

FIG. 16 shows how an IP classification system 700 operating in content consumption monitor 100 identifies different types of entities associated with IP addresses 454. IP classification system 700 leverages the fact that IP addresses 454 may be associated with different physical locations. For example, a first router 714A may have an associated IP address 454A (IP1) and may be associated with a private home location 710A. A second router 714B may have IP address 454B (IP2) and may be associated with a public business location 710B. A third router 714C may have IP address 454C (IP3) and may be associated with a private business location 710B.

For explanation purposes, private home location 710A may refer to any location associated with a relatively small group of people, such as a private residence. In at least one example, content accessed by users at private home location 710A may not necessarily be associated with a company. For example, persons living at private home location 710A may work for companies and may view work related content from private home location 710A. However, it may be unlikely that the majority of content accessed by users at private home location 710A are associated with a same company.

Public business location 710B may be associated with any entity, establishment, building, event, location, etc. that caters to multiple users that are not necessarily employed, or otherwise associated, with the same company, entity, establishment, etc. For example, public business location 710B may be a coffee shop run by a company that sells coffee to the general public. Content accessed by the different users at coffee shop location 710B may not necessarily be associated with the coffee company that operates the coffee shop. For example, users entering coffee shop location 710A may work for a variety of different companies and may view a variety of different content unrelated to the coffee company.

Private business location 710C may be associated with any entity, establishment, building, event, location, etc. where multiple users work, are employed, or are otherwise associated with the same business, entity, or establishment. For example, private business location 710C may be the corporate offices of the coffee company that runs coffee shop location 710B. In another example, private business location 710C may be the corporate offices of an entertainment or casino company that operates an amusement park and/or casino at public business location 710B.

Of course, in other examples the entities associated with IP locations 710B and 710C are unrelated. For example, the company at private business location 710C may not have retail stores or facilities. In at least in one example, users at private business location 710C may mostly work for the same company and may mostly view content related to their jobs at the same company.

As described above, tags 110 monitor content accessed by computing devices 130 at the different IP locations 710. Tags 110 generate events 108 that identify different parameters of the content accessed by the users at IP locations 710. As mentioned above, events 108 may include a user ID, URL, IP address, event type and timestamp. Events 108 also may include a device type and a time offset.

An IP feature generator 702 identifies the source IP addresses 454 in IP messages sent from tags 110 to CCM 100 that include events 108. Feature generator 702 identifies different features 704 of events 108 at the different IP address locations 710. For example, feature generator 702 may determine the average amount of content each user accesses at the different IP locations 710, the average amount of time users access content at the different IP locations 710, and when users access content at the different IP locations 710. Feature generator 702 also may determine what types of computing devices 130 are used for accessing content at the different IP locations 710.

An IP entity classifier 706 uses features 704 to determine types of establishments associated with IP locations 710. For example, features 704 may indicate a relatively small number of users access content at IP address location 710A. IP classifier 706 may accordingly identify IP address 454A as a home location.

IP classifier 706 may determine from features 704 that a relatively large number of users access content consistently throughout the day and on weekends at location 710B. IP classifier 706 also may determine from features 704 that most of the users at location 710B use smart phones to access content. IP classifier 706 may determine IP address 454B is associated with a public business location.

IP classifier 706 may determine from features 704 that users at IP location 710C mostly access content during business hours Monday through Friday. IP classifier 706 also may determine from features 704 that most of the users at location 710C use personal computers or laptop computers to access content. IP classifier 706 may determine IP address 454C is associated with a private business location.

IP classifier 706 may generate an IP entity map 708 that identifies the types of establishments associated with the IP address locations 710. CCM 100 uses IP entity map 708 to more efficiently and effectively generate consumption scores and identify surges for different companies. For example, CCM 100 may distinguish between multiple IP addresses owned by the same company that include both public business locations and private business locations. In another example, CCM 100 may identify multiple different companies operating within in a shared office space location.

CCM 100 may generate different consumption scores 410 (FIGS. 8 and 9) for the different IP address locations 710 or may only provide consumption scores 410 for IP addresses associated with private business locations 710C. In another example, some publishers 118 may be more interested in consumption scores 410 for a certain demographic of users that patronize retail locations 710B of particular businesses. CCM 100 may generate consumption scores 410 and related surge data 412 for the events 108B associated with public business locations 710B for those businesses. Thus, CCM 100 can filter out events that are less likely to indicate the current interests of associated businesses, business customers, or any other definable entity or demographic.

It is also worth noting that IP classification system 700 may generate IP entity map 708 without using personal identification information (PII). Events 108 may include a user identifier 450 (see FIG. 9). However, classification system 700 can classify IP address locations 710 based only on event timestamps and/or device types. Thus, CCM 100 can generate consumption scores for particular company IP addresses without using PII data. Publishers 118 are then free to use their own contact lists to send content to particular companies based on the associated company consumption scores.

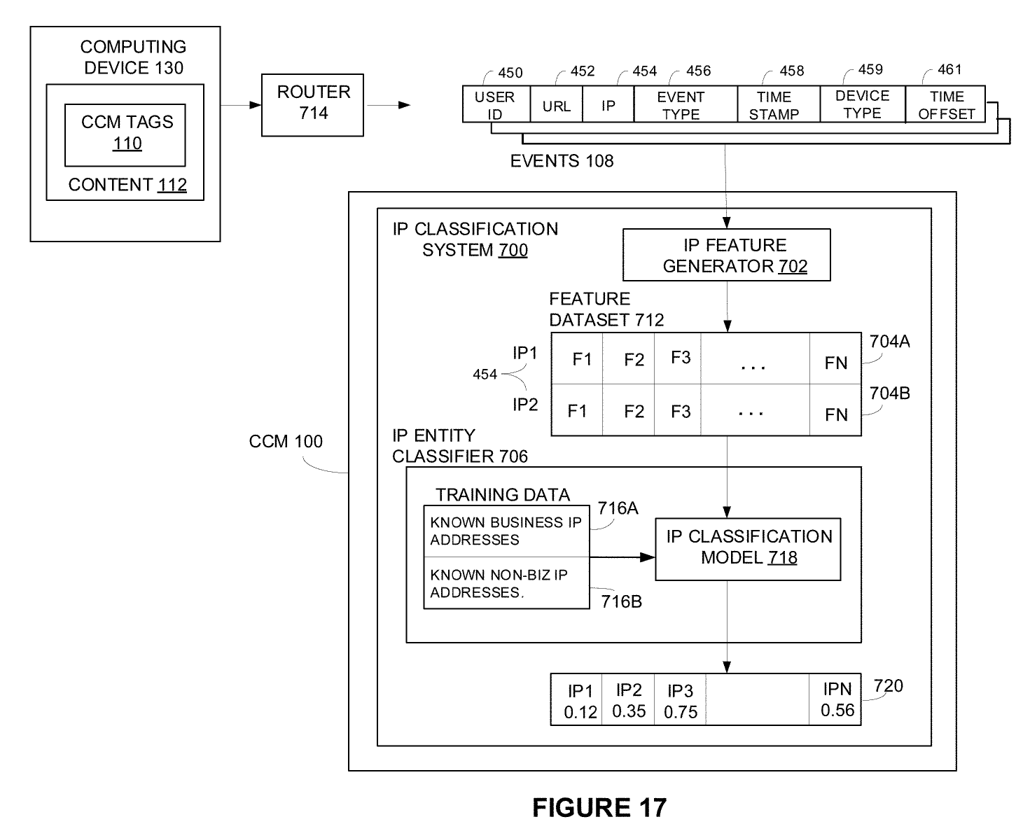

FIG. 17 shows in more detail how IP classification system 700 identifies the types of establishments associated with IP address locations. As described above, events 108 may include a user identifier (ID) 450 such as a unique cookie ID, a URL 452 identifying content accessed by a user associated with user ID 450, an IP address 454, and a time stamp 458. Events 108 also may include a device type 459 and a time offset 461.

IP address 454 may be the IP address of the router or switch 714 at the physical location where tags 110 generate events 108. Tags 110 may send IP messages to CCM 100 every 15 seconds via router 714. The messages contain events 108 and include a source IP address for router 714 that CCM 100 uses to send acknowledgement messages back to tags 110.

Tags 110 may discover device type 459 of the computing device 130 that the user uses to access content 112. For example, tags 110 may identify computing device 130 as a personal computer, laptop, tablet, or smart phone based on the web browser screen resolution, type of web browser used for viewing content 112, or a type of user agent used by the web browser.

Tags 110 also may add a time offset 461 corresponding with the time zone associated with events 108. Classification system 700 can adjust all time stamps 458 from all IP address locations to correspond to a same universal time.

IP feature generator 702 may produce a variety of different features 704 for each IP address 454 based on any combination of parameters in events 108. As described above, feature generator 702 may generate some features 704 based on time stamps 458 and/or device type 459. In one example, feature generator 702 may generate a new feature dataset 712 each day, or over some other selectable time period. Several features 704 have been described above and additional features 704 are described below in more detail.

IP entity classifier 706 may use an IP classification model 718 to identify types of establishments associated with IP addresses 454. In one example, classification system 700 uses a logistic regression (LR) model 718 as follows:

N⁻¹ log L(θ|x)=N⁻¹Σᵢ₌₁^{N} log Pr(yᵢ|xᵢ;θ)

where: N is_number of observations; L is loss function; Θ is parameters/coefficients used to calculate probability, Pr is probability, yᵢ is class (0 or 1) of the ith observation, and is a vector of features representing an IP. Logistic regression models and other types of models used for identifying different behavior patterns are known to those skilled in the art and are therefore not described in further detail.

IP classification system 700 trains model 718 with training data 716. A first set of training data 716A may include features 704 for IP addresses 454 from known private business locations. For example, training data 710A may be produced from events 108 generated from the known corporate headquarters or known business offices of companies.

A second set of training data 716B may include features 704 for IP addresses from known public business locations or known non-business locations. For example, training data 710B may be generated from coffee shops, retail stores, amusement parks, internet service providers, private homes, or any other publicly accessible Internet location.

In one example, model 718 uses training data 716 to identify features 704 associated with private business locations. However, model 718 may be trained to identify any other type of physical IP location, such as public business locations, private home locations, geographic locations, or any other business or user demographic.

Classification system 700 feeds features 704 for a particular IP address 454 into trained model 718. Model 718 generates prediction values 720 that indicate the probability of the associated IP address being a private business location. For example, classification system 700 may identify any IP address 454 with a prediction score 720 over 0.45 as a private business location. Conversely, classification system 700 may identify any IP address 454 with a prediction score 720 less than some other threshold as a public business location or a private home location. Classification system 700 generates IP entity map 708 in FIG. 16 from prediction values 720. For example, IP entity map 708 may include a row for each IP address 454 and a column marked if the associated IP address is identified as a private business location.

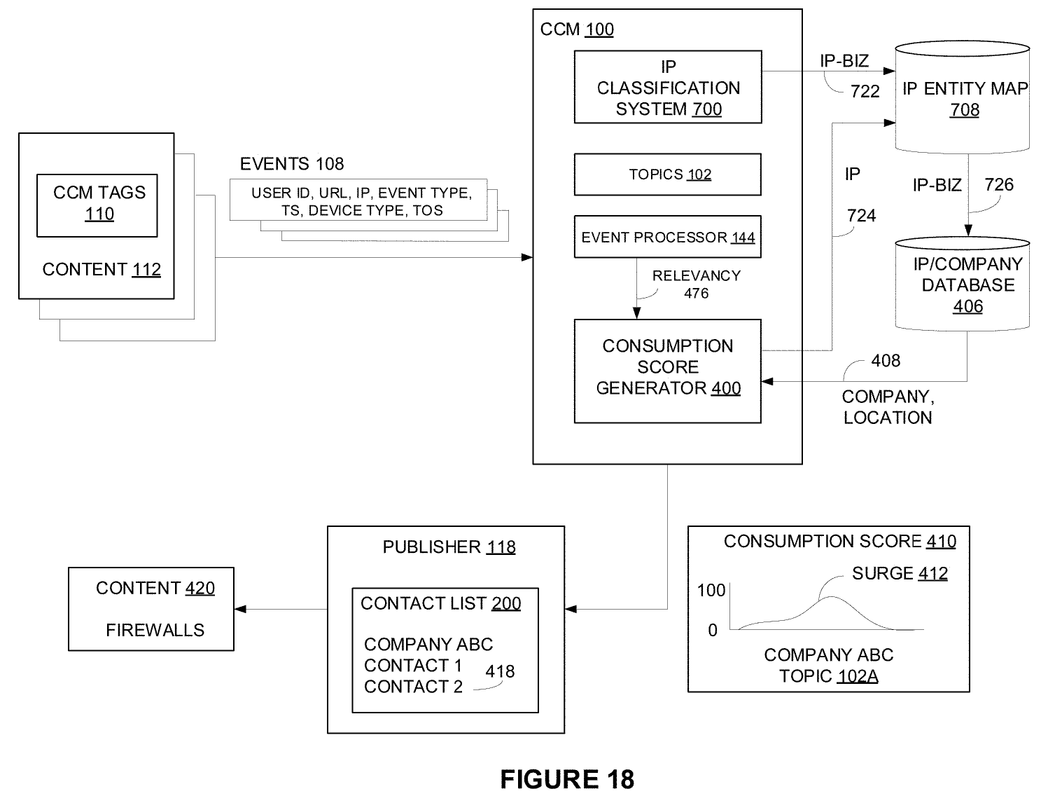

FIG. 18 shows how IP classification system 700 generates more accurate business consumption scores. As described above, IP classification system 700 identifies the types of establishments associated with different IP addresses. In this example, IP classification system 700 classifies IP addresses 722 as private business locations (IP-BIZ). The classified IP address are stored in IP entity map 708.

As explained above, a domain name service may provide a database 406 that identifies companies and company addresses associated with different IP addresses. The IP address and/or associated company or entity may be referred to generally as a domain. As also mentioned above, database 406 may include multiple different IP addresses associated with the same company. Some of these IP addresses may be associated with public business locations that do not necessarily identify the intent or interests of the company.

CCM 100 may receive a group of events having the same IP address 724. To generate more accurate consumption scores, CSG 400 may compare the IP address 724 associated with the group of events 108 with IP entity map 708. Map 708 indicates in output 726 if IP address 724 is associated with a private business location. If IP address 724 is not associated with a private business location, CSG 400 may not generate a consumption score 410. If output 726 indicates IP address 724 is associated with a private business location (IP-BIZ), CSG 400 may generate a consumption score 410 for the identified company and location 408.

CSG 400 calculates a consumption score 410 from events 108 that include the IP address 724 verified as associated with a private business location. As explained above, CSG 400 may generate consumption score 410 for a topic 102 based on an average topic relevancy score 476 for the group of events 108. CSG 400 may adjust consumption score 410 based on the total number of events 470, number of unique users 472, and topic volume 474 as described above in FIG. 9.

IP classification system 700 may continuously update IP entity map 708 and CSG 400 may continuously confirm which received IP addresses 724 are associated with private business locations. GSG 400 may stop generating consumption scores 410 for any IP addresses 724 that are no longer associated with private business locations. By filtering out events from public business locations and non-business locations, CCM 100 may more accurately identify topics of interest and surges for businesses.

As mentioned above, CCM 100 may send consumption scores 410 and/or any surge information 412 for the company 408 associated with IP address 724 to publisher 118. Publisher 118 may store a contact list 200 including contacts 418 for company 408. Publisher 118 may send content 420 related to topic 102A to contacts 418 when consumption data 410 identifies a surge 412.

In another example, CCM 100 may tag the profiles of users associated with the identified businesses 408. CCM 100 them may accumulate all of the user intent vectors associated with the same company as described above.

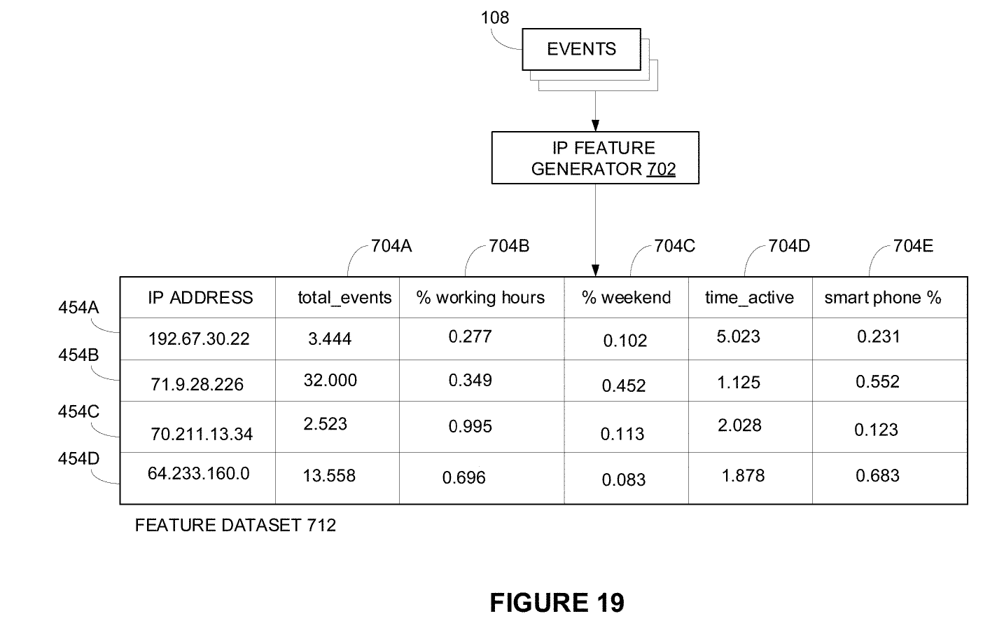

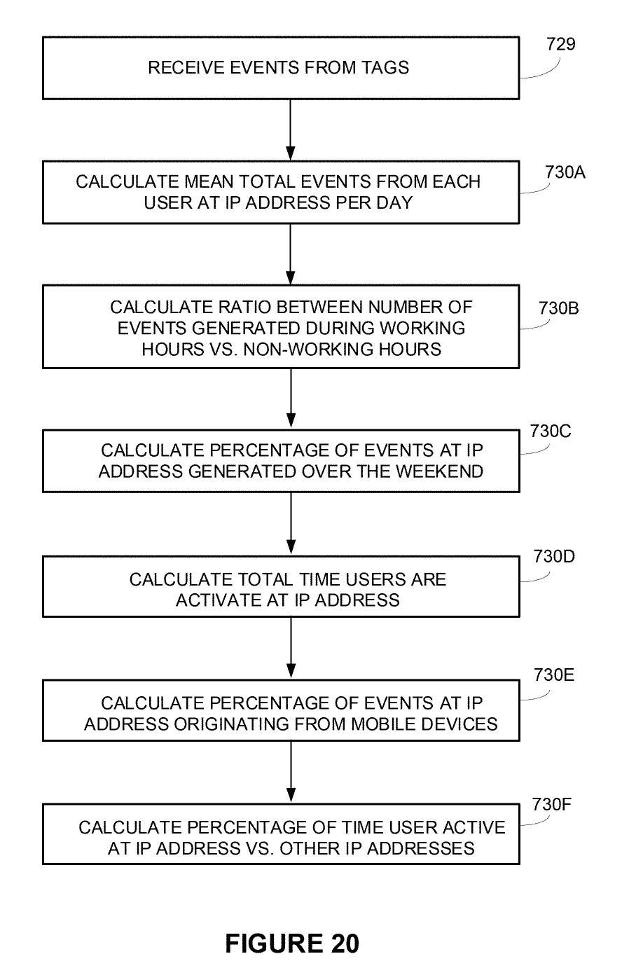

FIG. 19 shows examples of features generated by feature generator 702 from events 108 and FIG. 20 shows the associated operations performed by feature generator 702. As described above, any number of features/metrics can be generated from events 108 and then used by IP classification system 700 to classify IP addresses. Feature generator 702 may generate features 704 over any programmable time period, such as daily.

Referring to FIGS. 19 and 20, in operation 729 feature generator 702 receives events 108 that include associated IP addresses 454A-454D. Feature generator 702 may generate features 704A-704E using all of the events 108 received during that day that include the same IP address. Feature generator 702 may generate some features 704 as mean values, average values, ratios, percentages, normalized values, etc. The actual values shown in feature dataset 712 are just examples and may vary based on the specific calculations used by feature generator 702.

In operation 730A, feature generator 702 may calculate a feature 704A that identifies a mean total number of events generated at each IP address 454 during each day. For example, feature generator 702 may calculate the mean total events generated by each user from the IP address per day. Feature 704A may help distinguish IP addresses associated with businesses from other IP addresses associated with individuals.

In operation 730B, feature generator 702 may generate a feature 704B that identifies a ratio of events generated during working hours vs. events generated during non-working hours. For example, feature generator may calculate the mean number of events generated for each user between 8 am-6 pm compared with all other hours. Feature 704B may help distinguish IP addresses associated with private business locations where users generally access content during business hours from IP addresses associated with other public business locations where users may access content any time of the day.

In operation 730C, feature generator 702 may generate a feature 704C that identifies a percentage of events generated on weekends. Feature 704C also helps distinguish IP addresses associated with private business locations where users generally access content during work days from other public business locations and private home locations where users may access a higher percentage of content during the weekends.

In operation 730D, feature generator 702 may generate a feature 704D that identifies the amount of time users actively access content from the IP address. Feature generator 702 may identify the first time a particular user accesses content at the IP address during the day and identify the last time particular the user accesses content at the same IP address during that day. Feature 704D may help distinguish private business locations where users generally access different content throughout the day at the same business location vs. public business locations where users may only access content for a short amount of time while purchasing a product, such as coffee.

Feature generator 702 may extend the active time 704D as long as the user accesses some content within some time period. In another example, feature generator 702 may terminate active time periods when the user does not access content for some amount of time. Feature generator 702 then may identify the longest or average active time periods for each user and then calculate an average active time for all users that access content at the IP address 454. Many users at public business locations, such as a coffee shop, may have zero duration events since the user may only generate one event at that IP address.

In operation 730E, feature generator 702 may generate a feature 704E that identifies the percentage of content accessed by users with mobile device, such as cell phones. Feature 704E may help distinguish private business locations where users mostly use personal computers or laptops from public business locations where users may more frequently access content with cell phones.

In another example, feature generator 702 may calculate a percentage of time users are active at a particular IP address vs. other IP addresses. This also may help distinguish private business locations where users generally spend more time accessing content vs. public business locations where users may spend less time accessing content. In another example, feature generator may identify the average number of users that have accessed the same IP address over a week. A public business location may have a larger number of users access the IP address over a week.

Features used in the model may include, but is not limited to the following:

ip_p_during_business: The percent of an IPs activity that happens during business hours. “Business hours” being defined as 8 am-6 pm M-F. For example, an IP that is active 24/7 may have a value of 0.30. A business active 24 hours a day during M-F may have a value of 0.42;

mean_profile_p_during_business_global: This feature looks at the average percentage of activity during business hours of the profiles that have visited this IP address. This feature is different than ‘ip_p_during_business’ because it aggregates over the global behavior over profiles at the IP rather than only the profile at the IP;

mean_dow_active_global: An average over the profiles at an IP of how many days of the week they are active globally (i.e. across all IPs). For example, if there are two profiles at an IP, and one has been active 7 days (even if not at this IP for all 7 days) and another active for only 2 days the value may be 4.5;

mean_dow_active_at_ip: An average over the profiles at an IP of how many days of the week each profile is active only at the specific IP. So even if a user was active 7 days globally, but only 1 day at this IP, then only that 1 day would be considered;

mean_percent_weekday_at_ip: An average over the profiles of what percentage of their activity happened at the specific IP address during the week. For example, if all of a profile's traffic was Wednesday and Friday, their individual percent weekday would be 1. This feature is the mean of this metric for all profiles at an IP address;

mean_avg_start_hour_global: Averages across profiles at an IP the hour, in local time, of the profile's average first activity globally;

mean_avg_end_hour_global: Averages across profiles at an IP the hour, in local time, of the profile's average last activity globally;

mean_avg_start_hour_at_ip: Averages across profiles at an IP the hour, in local time, of the profile's average first activity only at the specific IP;

mean_avg_end_hour_at_ip: Averages across profiles at an IP the hour, in local time, of the profile's average last activity only at the specific IP;

mean_avg_duration_at_ip: For each profile at the IP, it takes the average “duration” of activity for each profile. The “duration” is defined as the last timestamp—first timestamp. This means that a profile with a single event will have a duration of 0. The duration of each day for each profile is averaged, then the average of all profiles is taken to provide the value for this feature;

mean_avg_duration_ratio: this is the ratio of the ‘duration_at_ip’ and the ‘duration_global’ averaged per profile then averaged across all these profiles;

mean_pages_visited_ratio: the ratio of pages viewed at this IP over the pages viewed globally per profile, averaged across all profiles;

mean_dow_active_ratio: the ratio of days of week active at this IP over the days of week active globally, averaged across all profiles;

mean_avg_start_hour_cliff: the feature looks at the difference between when a profile starts at the IP and globally, then averages this difference for each profile for the entire period then takes the average across all profiles;

mean_profile_p_during_business_ratio: average ratio of the percentage of profile activity that happens at the IP vs globally;

mean_avg_end_hour_cliff: the feature looks at the difference between when a profile ends at the IP and globally, then averages this difference for each profile for the entire period then takes the average across all profiles;

mean_p_sunday_evts_at_ip: Average over profiles at IP of what percentage of their hours are on Sunday;

mean_p_monday_evts_at_ip: Average over profiles at IP of what percentage of their hours are on Monday;

mean_p_tuesday_evts_at_ip: Average over profiles at IP of what percentage of their hours are on Tuesday;

mean_p_wednesday_evts_at_ip: Average over profiles at IP of what percentage of their hours are on Wednesday;

mean_p_thursday_evts_at_ip: Average over profiles at IP of what percentage of their hours are on Thursday;

mean_p_friday_evts_at_ip: Average over profiles at IP of what percentage of their hours are on Friday;

mean_p_saturday_evts_at_ip: Average over profiles at IP of what percentage of their hours are on Saturday;

mean_avg_daily_—_pages_visited: Looks at the average number of pages a profile visits at the IP per day, then averages these across all profiles at the IP;

percent_mobile: Percentage of traffic from IP that has the device type of mobile (note: only non-null values are used for this calculation);

percent_tablet: Percentage of traffic from IP that has the device type of tablet (note: only non-null values are used for this calculation);

percent_desktop: Percentage of traffic from IP that has the device type of desktop (note: only non-null values are used for this calculation);

normalized_entropy: This is a Shannon entropy of profile_atr_domain for the IP address. For example, it represents how much confusion there is amount profile_atr_domains for the IP. The Shannon entropy is then divided by the maximum possible entropy yielding a value between [0.0,1.0] which is the normalized entropy. Note that this value can be NaN when the Shannon entropy is 0. This has the interpretation that the normalized entropy should be 0;

profile_events_ratio: This feature compares the number of events generated by each profile at an IP, on average. In one example, the IP might have short-lived users, who generate an average of two events, thus this feature would have a value of 0.5. In another example, an IP might have many business users, who generate on average 10 events, resulting in this feature taking a value of 0.1. To note, the range for this feature is from (0,1] unlike more intuitive reciprocals which range from [1,infty);

ua_events_ratio: This feature is similar to profile_events_ratio only it uses the number of unique user agents instead of profiles;

log 10_mean_ips_visited: The log 10 transform of the average number of IP addresses visited by each profile at this IP;

log 10_mean_pages_visited_global: The log 10 transform of the average number of pages visited/viewed globally by profiles that have been at this IP address;

log 10 mean_pages_visited_at_ip: The log 10 transform of the average number of pages visited/viewed globally by profiles that have been at this IP address; and

log 10_mean_avg_daily_ips_visited: This is the same as log 10 mean_ips_visited only it first averages over the daily IPs visited per profile.

Feature generator 702 may identify any other feature 704 that indicates how users may access content at different IP locations. As explained above, IP classification system 700 uses feature dataset 705 to then identify the different types of establishments associated with different IP addresses.

It should also be understood that, beyond predicting whether or not an IP is behaving like a business, the above scheme can be used to make more general inferences about the type of physical location (e.g., hotel, coffee shop, hospital) or underlying application or process (e.g., mobile network operator, university, botnet) the network the IP address supports. For instance, their exists possibility of inferring additional firmographic attributes, such as industry, company size, etc.

### Hardware and Software

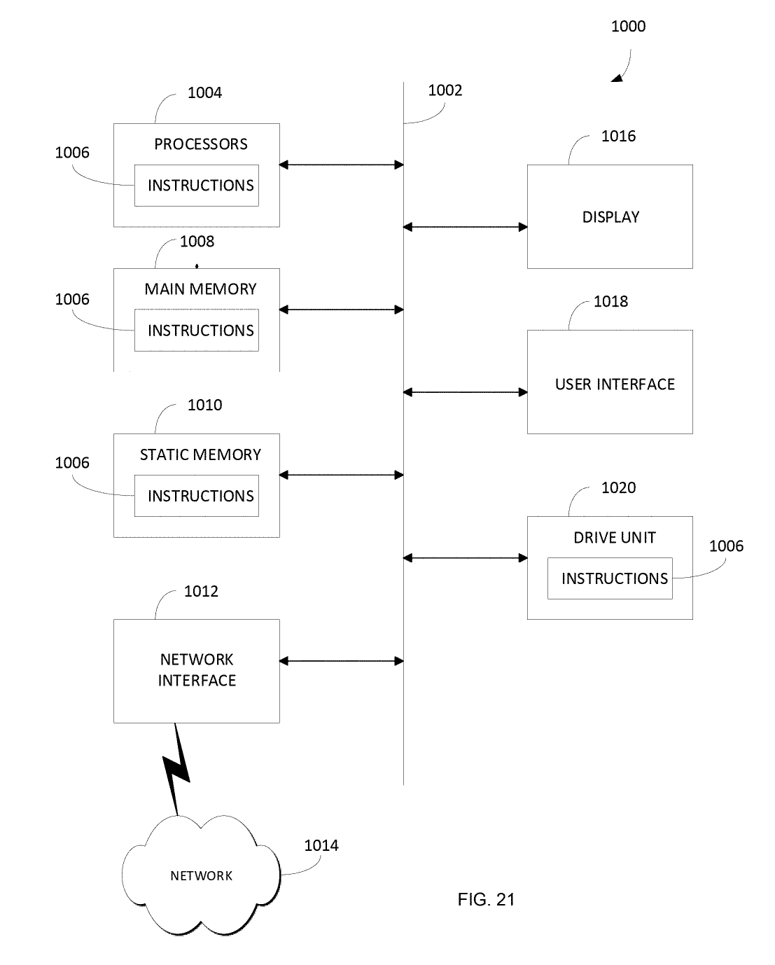

FIG. 21 shows a computing device 1000 that may be used for operating the content consumption monitor and performing any combination of processes discussed above. The computing device 1000 may operate in the capacity of a server or a client machine in a server-client network environment, or as a peer machine in a peer-to-peer (or distributed) network environment. In other examples, computing device 1000 may be a personal computer (PC), a tablet, a Personal Digital Assistant (PDA), a cellular telephone, a smart phone, a web appliance, or any other machine or device capable of executing instructions 1006 (sequential or otherwise) that specify actions to be taken by that machine.

While only a single computing device 1000 is shown, the computing device 1000 may include any collection of devices or circuitry that individually or jointly execute a set (or multiple sets) of instructions to perform any one or more of the operations discussed above. Computing device 1000 may be part of an integrated control system or system manager, or may be provided as a portable electronic device configured to interface with a networked system either locally or remotely via wireless transmission.

Processors 1004 may comprise a central processing unit (CPU), a graphics processing unit (GPU), programmable logic devices, dedicated processor systems, micro controllers, or microprocessors that may perform some or all of the operations described above. Processors 1004 may also include, but may not be limited to, an analog processor, a digital processor, a microprocessor, multi-core processor, processor array, network processor, etc.

Some of the operations described above may be implemented in software and other operations may be implemented in hardware. One or more of the operations, processes, or methods described herein may be performed by an apparatus, device, or system similar to those as described herein and with reference to the illustrated figures.

Processors 1004 may execute instructions or “code” 1006 stored in any one of memories 1008, 1010, or 1020. The memories may store data as well. Instructions 1006 and data can also be transmitted or received over a network 1014 via a network interface device 1012 utilizing any one of a number of well-known transfer protocols.

Memories 1008, 1010, and 1020 may be integrated together with processing device 1000, for example RAM or FLASH memory disposed within an integrated circuit microprocessor or the like. In other examples, the memory may comprise an independent device, such as an external disk drive, storage array, or any other storage devices used in database systems. The memory and processing devices may be operatively coupled together, or in communication with each other, for example by an I/O port, network connection, etc. such that the processing device may read a file stored on the memory.

Some memory may be “read only” by design (ROM) by virtue of permission settings, or not. Other examples of memory may include, but may be not limited to, WORM, EPROM, EEPROM, FLASH, etc. which may be implemented in solid state semiconductor devices. Other memories may comprise moving parts, such a conventional rotating disk drive. All such memories may be “machine-readable” in that they may be readable by a processing device.

“Computer-readable storage medium” (or alternatively, “machine-readable storage medium”) may include all of the foregoing types of memory, as well as new technologies that may arise in the future, as long as they may be capable of storing digital information in the nature of a computer program or other data, at least temporarily, in such a manner that the stored information may be “read” by an appropriate processing device. The term “computer-readable”may not be limited to the historical usage of “computer” to imply a complete mainframe, mini-computer, desktop, wireless device, or even a laptop computer. Rather, “computer-readable” may comprise storage medium that may be readable by a processor, processing device, or any computing system. Such media may be any available media that may be locally and/or remotely accessible by a computer or processor, and may include volatile and non-volatile media, and removable and non-removable media.

Computing device 1000 can further include a video display 1016, such as a liquid crystal display (LCD) or a cathode ray tube (CRT)) and a user interface 1018, such as a keyboard, mouse, touch screen, etc. All of the components of computing device 1000 may be connected together via a bus 1002 and/or network.

For the sake of convenience, operations may be described as various interconnected or coupled functional blocks or diagrams. However, there may be cases where these functional blocks or diagrams may be equivalently aggregated into a single logic device, program or operation with unclear boundaries.

Having described and illustrated the principles of a preferred embodiment, it should be apparent that the embodiments may be modified in arrangement and detail without departing from such principles. Claim is made to all modifications and variation coming within the spirit and scope of the following claims.

1. A system for analyzing events associated with an internet protocol (IP) address, comprising:
a processor; and
one or more stored sequences of instructions which, when executed by the processor, are operable to:
receive events associated with users accessing content from the IP address;
generate features from the events identifying how the users access the content at a physical location associated with the IP address; and
identify a type of entity associated with the IP address based on the features.

2. The system of claim 1, wherein the instructions, when executed by the processor, are further operable to identify the type of entity associated with the IP address based on when the users access the content.

3. The system of claim 1, wherein the instructions, when executed by the processor, are further operable to:
identify a time range associated with working hours;
identify a ratio of the events generated during the working hours vs. non-working hours; and
identify the type of entity associated with the IP address based on the ratio.

4. The system of claim 3, wherein the instructions, when executed by the processor, are further operable to:
identify the type of entity as a private business location when the ratio of events during business hours vs. non-business hours is above a threshold; and
identify the type of entity as a public business location or a non-business location when the ratio of events during business hours vs. non-business hours is below the threshold.

5. The system of claim 1, wherein the instructions, when executed by the processor, are further operable to identify the type of entity associated with the IP address based on a number of the events generated during a work week vs. a number of the events generated during a weekend.

6. The system of claim 1, wherein the instructions, when executed by the processor, are further operable to identify the type of entity associated with the IP address based on one of the features identifying durations of time the users are accessing the content at the IP address.

7. The system of claim 1, wherein the instructions, when executed by the processor, are further operable to identify the type of entity associated with the IP address based on one of the features identifying types of computing devices used for accessing the content at the IP address.

8. The system of claim 7, wherein the instructions, when executed by the processor, are further operable to:
identify the type of entity as a private business location when a ratio of computing devices including laptop and personal computers (PCs) compared with smart phones is above a threshold; and
identify the type of entity as a public business location when the ratio is below the threshold.

9. The system of claim 1, wherein the instructions, when executed by the processor, are further operable to:
identify a domain for the IP address when the type of entity associated with the IP address is identified as a private business location; and
generate a consumption score for the domain when the type of entity associated with the IP address is identified as a private business location.

10. An apparatus, comprising:
a processing unit operable to:
receive events identifying how users access content;
identify internet protocol (IP) addresses for the events, the IP addresses associated with locations where the users access the content;
use time stamps in the events to determine when users access the content at the locations associated with the IP addresses; and
identify types of establishments associated with the IP addresses based on when the users access the content at the locations associated with the IP addresses.

11. The apparatus of claim 10, wherein the processing unit is further configured to:
identify IP addresses where a particular percentage of the events occur during working business hours; and
identify the types of establishments for the identified IP addresses as private business locations.

12. The apparatus of claim 10, wherein the processing unit is further configured to:
identify IP addresses where the users access the content over a particular duration of time; and
identify the types of establishments for the identified IP addresses as private business locations.

13. The apparatus of claim 10, wherein the processing unit is further configured to:
identify from the events types of computing devices used for accessing the content;
identify IP addresses where a particular percentage of the computing devices are smart devices; and
identify the types of establishments for the identified IP addresses as public business locations.

14. The apparatus of claim 10, wherein the processing unit is further configured to:
identify the IP addresses where a number of the events during a specified time period is below a threshold; and
identify the types of establishments for the identified IP addresses as non-business locations.

15. The apparatus of claim 10, wherein the processing unit is further configured to:
identify the IP addresses associated with private business locations;
identify companies associated with the identified IP addresses; and
generate consumption scores from the events with the identified IP addresses associated with the companies.

16. An apparatus, comprising:
a processing device;
a memory device coupled to the processing device, the memory device having instructions stored thereon that, in response to execution by the processing device, are operable to:
identify events associated with an entity;
identify content associated with the events;
identify internet protocol (IP) addresses associated with the events;
identify types of locations associated with the IP addresses based on how users at the IP addresses access the content;
filter the IP addresses based on the types of locations associated with the IP addresses; and
calculate consumption scores for the filtered IP addresses

17. The apparatus of claim 16, wherein the processing unit is further configured to identify some of the IP addresses as private business locations based on when the users access the content at the IP addresses.

18. The apparatus of claim 16, wherein the processing unit is further configured to:
identify the number of events associated with the IP addresses over a series of time periods; and
adjust the consumption scores based on changes in the number of events over the series of time periods.

19. The apparatus of claim 18, wherein the processing unit is further configured to:
identify a number of users generating the events over the series of time periods; and
adjust the consumption scores based on changes in the number of users over the series of time periods.

20. The apparatus of claim 16, wherein the processing unit is further configured to:
identify publishers;
identify some of the content provided by the publishers;
generate relevancy values of the content to a topic;
weight the relevancy values based on the content being provided by the publishers; and
generate the consumption scores for the filtered IP addresses based on the weighted relevancy values.
